(19) United States
(12) Patent Application Publication
(10) Pub. No.: US 2015/0100463 A1
(43) Pub. Date: Apr. 9, 2015

(54) COLLABORATIVE HOME RETAILING SYSTEM

(71) Applicants: Jonathan Peter Vincent Drazin, Reading Berkshire (GB); Simple Matters Limited, Reading Berkshire (GB)

(72) Inventor: Jonathan Peter Vincent Drazin, Reading Berkshire (GB)

(21) Appl. No.: 14/400,991

(22) PCT Filed: May 24, 2013
(86) PCT No.: PCT/GB2013/051386

§ 371 Date: Nov. 13, 2014

(30) Foreign Application Priority Data
May 25, 2012 (GB) 1209212.8

(51) Int. Cl. G06Q 30/06; G06Q 50/00

(52) U.S. Cl. CPC G06Q 30/0641; G06Q 50/01
USPC 705/27.1

(57) ABSTRACT

A handheld device operable to connect to a data communication network, wherein the device comprises: a screen, a user input device, and a controller adapted to form or change a group that includes the device and at least one other handheld device and adopt a leader device or follower device status. When the leader status is adopted, the controller is adapted to display an item in response to a user input and transmit data indicative of the item to the at least one other device in the group. When the follower device status is adopted, the controller is adapted to receive data indicative of an item from a leader device and display information corresponding to the indicative data.

### BACKGROUND OF THE INVENTION

The emergence of Internet connected televisions (TVs) and set-top-boxes (STBs) in recent years has created new fields of opportunities for users to interact and benefit from TV. One field is electronic retailing of products to shoppers. However, retailing via TV is less popular with consumers compared to via alternative media such as personal computers (PCs) and personal networked devices (PNDs) such as smart phones and tablets. TVs make comparatively poor tools for shopping because they are difficult to interact with and are not perceived to afford sufficient privacy for purchase transactions due to their shared screens and common use.

Users experience difficulties when they use PNDs as shopping devices. One problem is that smart phones are frequently too small to view a product clearly. The same can be true of tablets when it is considered that retail applications need often to display simultaneously a product description and illustrations for user convenience. Examination of products is a fundamental difficulty for smart phone and tablet users. A means is required whereby products can be displayed faithfully and in detail where, preferably, a smart phone or table user should be able to perform a process equivalent to picking up a product, rotating it and inspecting it from all sides in a physical retail store.

Another problem is that many product purchases require consultation with other persons (e.g. because a product is expensive, of shared interest or difficult to comprehend). Shoppers commonly abandon buying products from mobile devices because they are unsure. Typically in such cases shoppers send e-mails or posts via Facebook or Twitter to trusted friends for advice, where responses arrive too late and after the shopper has had to abandon shopping. Shoppers need instantly to contact friends or other shoppers and receive feedback and assurances from them in real time, simultaneously while they are shopping, where the result of a shopper obtaining assurances simultaneous to interacting with a shopping application increases a purchase's likelihood.

Users often experience inconvenience when repeatedly moving their heads and changing their field of vision between near controls and keys on handheld devices (e.g. smart phones and tablets) and far devices such as TVs or display monitors. It would consequently be desirable for viewers when viewing different products or views and variants (e.g. colour, style) of the same product on far field devices (e.g. TVs) to switch display of the variants without looking at a near field device.

A PND user may not want to show another person all that is displayed on the PND. For example, the user may not want to show his/her login details or a product's price. A hybrid system of TV and PND is desired where some items of product information (e.g. photographs and text descriptions) are available for shared viewing while other information is displayed for private viewing by the PND user only (e.g. price, terms of payment and transaction security).

The accessibility and flexibility of PNDs make them increasingly preferred devices for TV remote control over conventional infra-red remote control units (RCUs). TV remote control applications for PNDs (e.g. the Google TV remote application) already allow users to control their TVs across a local area network (LAN). However, users cite many reasons for not using PNDs as remote controls which include: unwanted battery drain, distractions from emitted light or sound from PNDs while they are watching TV (especially in darkened rooms), inconvenience from having repetitively to re-enter their personal identity numbers or login codes to PNDs when returning to use remote control applications and having repetitively to re-start their remote control applications. Means are therefore required to sense when a PND is not in use when a foreground remote control application is in operation and to cause the PND to go into a non-light emitting, lower power “sleep” state when the application is sensed to be not in use, and to wake the PND to resume to a user operable state of remote control application when the PND is picked up by a user.

Retailers using electronic points of sale, such as smart phones and tablets, face problems with encouraging shoppers to return to use their retail applications because it is normally technically and practically infeasible for retailers to target display of their advertisements over the internet to specified types of PNDs which contain their retail application. It is normally infeasible for users to click through on such advertisements from a PND's resident browser to start applications outside of the browser employed to view the advertisement.

New technologies (e.g. those employing the Apple AirPlay protocol) have emerged that send content and commands from controlling devices (such as smart phones) to TVs, but where the reliability of such systems is often constrained by range limitations of wireless networks commonly found in many homes when high bandwidths (e.g. video) must be streamed.

Other systems, such as for example those based on RVU Alliance protocols, transform the master controlling device into a thin client server and require interoperability with TVs and serving devices such as digital video recorders (DTRs) and network attached storage (NAS) devices. In common with content streaming, thin client protocols can require significant computational power to generate the client display, encode it in real time and stream it. Thin client servers are as a consequence not easily hosted within PNDs and may introduce unacceptable battery drain.

### SUMMARY OF THE INVENTION

In accordance with one aspect of the invention, a master displays an item of product information (e.g. a product catalogue or partial description) that causes related items to be displayed on the slave. For example, a user may search for an item of interest in the product catalogue displayed on the master which in turn causes certain related information to be displayed on the slave.

The master device sends links to external product information content to a slave device across the wireless network (rather than streaming the content itself) and controls the slave to play the links in time synchronisation with processes in the master. A shopper can share product information readily with friends and family, where an administrator of a household or location should be able to transmit network access information to other users of PNDs in a way that does not require users to recall or input information. The invention can be based on a Universal Plug and Play (UPnP) open architecture protocol. This provides a framework for home appliances to be linked on a local area network without manual network configuration where devices can be configured as slaves for the purpose of rendering content. However, several TVs may exist on a home network and it is desired that masters should discriminate and authenticate themselves to the correct slave quickly with minimum involvement from the user. It is necessary therefore to overcome a difficulty of registering a master to a particular network used by a slave. Users commonly experience difficulty with wireless networks, identifying the desired network identity (SSID), security scheme (e.g. WEP, WPA) and security keys or passphrases because they may not be readily to hand. Even when they are available, difficulties are experienced keying in the necessary access information.

Collaborative efforts are required from multiple industrial entities, including retailers and providers of slave devices, to implement and maintain the processes of the invention. A problem results as to how to remunerate each entity according to its contribution to the performance of the system of the invention compared to when a slave device is not employed.

According to one aspect of the invention, there is provided a handheld device operable to connect to a data communication network, wherein the device comprises: a screen, a user input device, and a controller adapted to form or change a group that includes the device and at least one other handheld device and adopt a leader device or follower device status; wherein when the leader status is adopted, the controller is adapted to display an item in response to a user input and transmit data indicative of the item (for example a url) to the at least one other device in the group; and wherein when the follower device status is adopted the controller is adapted to receive data indicative of an item from a leader device and display information corresponding to the indicative data.

In the device, a co-browsing tool may be provided to enable the controller to transmit data indicative of the item when the leader status is adopted and to display information corresponding to the indicative data when the follower status is adopted.

The controller may be operable to allow leader and follower status to be swapped.

The controller may be operable to determine which device in the group first starts or brings into focus an application for viewing the item, wherein leader status is conferred on the determined first device. A clock may be provided for monitoring the time at which the application is opened.

The controller may be operable to cause a fixed display device, for example a television, to display the item or information relating to the item when in leader device status.

The controller may be operable to change the representation of the item or information relating to the item when in leader device status.

The controller may be adapted to cause rotation of the item on the fixed display device when in leader device status.

Physical rotation of the leader device may cause rotation of the item or the representation of the item.

The controller may be adapted to transfer control of the fixed display device to another device in the group. Transfer may be conditional upon receipt of an acceptance signal from the other device.

When in leader status, the device may be operable to indicate to the follower device that the fixed display device is available.

The controller may be adapted to indicate availability to join the group of another handheld device outside of the group. For example, the controller may be operable to display an icon indicative of the presence of another group.

The controller may be adapted to change the group by merging the group with another group.

The controller may be adapted to form or change the group by detecting an event common to a pair of devices. The event may comprise at least one of: proximity detection; detection of a tap or shake; detection of a near field communication signal; detection of a spoken command; detection of a gesture. The device may be operable to exchange a first time measurement with the other device of the pair, and adopt a leader or follower status in response to a message from the other device based on the first time measurement.

The controller may be operable to form or change the group conditional upon a prior preference or indication of acceptance. The prior preference may be to accept or reject inputs from the other devices.

The device may be configured to display identities of the other devices of the group.

The device may be operable to display a list of device identities; detect selection of one of the device identities, and join a group that comprises a device corresponding to the device identity selected.

The device may be configured to establish an audio conference call or text chat session with at least one other handheld device in the group.

The device may be operable to: record a first time when the group is formed or changed or when a fixed device is caused to display additional information; transmit the first time and the identity of the item to a remote server or device; record a second time corresponding to a transaction time; and transmit the second time and the identity of the item to the remote server or device.

According to another aspect of the invention, there is provided a system comprising a plurality of handheld devices according to the first aspect, at least one of the devices having leader status and at least one of the devices having follower status.

A remote server or device may be provided to compare a first time a group is formed or changed or when a fixed device is caused to display additional information, and second time corresponding to a transaction time.

According to a further aspect of the invention, there is provided a method of sharing product information using a plurality of handheld devices that are connectable to a data communication network, comprising forming a group of devices; defining a group leader and one or more group followers; displaying an item on the leader device; transmitting from the leader device data indicative of the item (for example a url) to the at least one follower device; receiving at the follower device data indicative of the item and displaying information on the follower device corresponding to the indicative data.

The method may involve determining which device in the group first starts or brings into focus an application for viewing the item and conferring leader status on the determined first device. Determining which device is the first may involve monitoring the time at which the application is opened.

The method may involve displaying data indicative of the item on a fixed display device, for example a television.

The method may involve changing the representation of the item or information, for example, causing rotation of the item on the fixed display device. Physical rotation of the leader device may cause rotation of the item or the representation of the item.

The method may involve transferring control of the fixed display device to another device in the group. Transfer may be conditional upon receipt of an acceptance signal from the other device.

Forming or changing the group may involve detecting an event common to a pair of devices. The event may comprise at least one of: proximity detection; detection of a tap or shake; detection of a near field communication signal; detection of a spoken command; detection of a gesture.

The method may involve exchanging a first time measurement between two or more devices, and adopting a leader or follower status in response to a message from the other device based on the first time measurement.

The method may involve recording a first time when the group is formed or changed or when a fixed device is caused to display additional information; transmitting the first time and the identity of the item to a remote server or device; recording a second time corresponding to a transaction time; and transmitting the second time and the identity of the item to the remote server or device.

According to yet another aspect of the invention, there is provided a handheld device comprising a screen, a user input device, and a controller adapted to control remotely a display device, such as a television, in response to a user input, wherein the handheld device is operable to determine when it is in use. The handheld device may be any personal networked device, such as a smartphone or tablet.

The device may be operable to display on the screen an advertisement on the handheld device, preferably for a fixed period of use. The advertisement may be displayed conditionally upon determination of a match between the advertisement and a viewed television programme.

The device may be operable to detect physical movement to determine use.

The device may be operable to reduce power consumption when it is not in use. This may be done by for example darkening the screen when not in use.

The device may be operable to execute an application whose identity corresponds to an identity embedded within an advertisement.

The device may be operable to allow selection of an advertisement; and cause display of product information related to the advertisement on a secondary display, for example a television screen.

According to yet another aspect of the invention, there is provided an interactive home shopping system comprising at least one master device and at least one slave device, wherein each master device is operable to receive product information, for example an advertisement; display the product information to a first display; and transmit related product information to the at least one slave device for display to a second display, wherein the master device is operable to send a command to the slave device to modify the appearance of the related product information and the slave device is adapted to modify the appearance of the related product information and display it accordingly.

The related product information may be displayed as a function of the capability of the second display.

The related product information may comprise an image or video of a product. The image or video of the product may be displayed by the slave for stereoscopic viewing.

The command to modify may be operable to change an apparent orientation or distance to a user of an image of the product.

The device may be configured to display a representation of a three dimensional framework or reference markers adjacent to or alongside the product information or related product information.

The master device may be operable to send a command to the slave device to modify the appearance in response to a user input.

The user input may be by means of a gesture or movement applied to the master device.

The user input to the master device may be at least one of: selection of one or more screen controls; and physical orientation of the master device.

The master device may be operable to record its orientation immediately prior to selection; and transmit its change in orientation to the slave device; and the slave device is operable change the orientation of the product displayed within the product image accordingly. To eliminate involuntary movement of the master device, the master device may be operable to filter orientation data.

The modification may be a selection of a variant of a product.

An input to the master device causes a next selection.

An input to the master device may terminate display of the related product information on the second display.

The master device may be operable to provide feedback to a user when display of the modified product information on the second device is completed. The feedback may comprise haptic feedback.

The master device may be a handheld device, such as a smart phone.

The slave device may be a fixed device, for example a television.

### BRIEF DESCRIPTION OF THE DRAWINGS

Various aspects of the invention will now be described by way of example only and with reference to the accompanying drawings, where:

FIG. 1 is a block diagram of the system of the invention.

FIG. 2 is an illustration of exemplary master device.

FIG. 3 shows a block diagram of an exemplary master device.

FIG. 4 is a block diagram of a client application and a retail application within exemplary system architecture on a master device.

FIG. 5 shows a block diagram of an exemplary slave device.

FIG. 6 is a block diagram of a client application coupled to a browser within exemplary system architecture on a slave device.

FIG. 7 is a block diagram of an administrator registering a TV slave to an administration server according to step 10-2 as later described.

FIG. 8 is a block diagram of an administrator registering a STB slave to an administration server according to step 10-2 as later described.

FIG. 9 shows a user with stereoscopic viewing glasses in a session with a TV slave according to steps 10-7 through to 10-9 as later described.

FIG. 10 shows the overall steps in a process to engage in a master-slave session.

FIG. 11 is a block diagram of an administrator configuring a TV slave to an administration server according to step 10-2 as later described.

FIG. 12 is an exemplary illustration of a scene on a user's master device according to step 10-4 as later described.

FIG. 13 is a data flow diagram for an administrator configuring a slave via a master according to step 10-4 as later described.

FIG. 14 is a data flow diagram for an administrator granting a certificate to a user according to step 10-6 as later described.

FIG. 15 is a block diagram of an administrator granting certificates to a user according to step 10-6 as later described.

FIG. 16 is an exemplary scene on an administrator's master's screen when granting a certificate to a user according to step 10-6 as later described.

FIG. 17 is an exemplary scene on a user's master's screen when it is receiving a certificate.

FIG. 18 is an exemplary data table compiled and stored within a master device.

FIG. 19A shows an exemplary group of users comprising a leader shopper and a plurality of follower shoppers.

FIG. 19B shows the flow of input from a follower's retail application into a leader's retail application.

FIG. 20 shows the steps whereby a user starts retail application and acquires a leader or follower shopping status.

FIG. 21 shows an exemplary display generated by retail application when existing shopper is discovered, whereby a user may enroll either as a follower or as a lone shopper.

FIG. 22 shows an exemplary display generated by a retail application whereby a user has requested to follow a shopper.

FIG. 23 shows an exemplary leader's display replicated on a follower's screen.

FIG. 24 is a flow chart of a process whereby two shoppers bump their master devices together to form a group or change group status.

FIG. 25 shows the composition of data that describe scenes displayed by master and slave.

FIG. 26 shows an exemplary leader's display.

FIG. 27 is a flow chart showing the steps of discovering a slave and authenticating master according to step 10-7 as later described.

FIG. 28 is a data flow diagram for a user pairing a master with a slave in near field proximity according to step 10-7 as later described.

FIG. 29 shows an exemplary scene on a user's master's screen when selecting a slave for pairing according to steps 27-3K through to 27-3N to be described.

FIG. 30 shows a process whereby a master displays the availability of a product link conditionally according to a slave's capabilities.

FIG. 31 shows exemplary display on user's master for remote control of a slave for TV viewing purposes.

FIG. 32A shows the steps whereby a remote control application on a master displays an advertisement for a fixed period of active use.

FIG. 32B shows the steps whereby a remote control application on a master opens a retail application that is specified within an advertisement.

FIG. 33 shows a state diagram for a master when operating a remote slave control feature.

FIG. 34 shows the steps whereby a master remote control maintains quick usability when operating a remote slave control feature.

FIG. 35A shows steps in the operation of a master-slave retail session across a LAN according to the sub-steps of 10-9 as later described.

FIG. 35B shows the steps whereby a user interacts with the slave via a master.

FIG. 36 is a data flow diagram for operation of a master-slave session across a LAN according to the sub-steps of 10-9 as later described.

FIG. 37 is an exemplary scene displayed by a slave according to step 10-9 as later described.

FIG. 38 is an exemplary scene of a slave remote control user interface displayed to master screen during step 10-8.

FIG. 39 is an exemplary scene of a slave control user interface with touch and stroke navigation displayed to master screen during step 10-8.

FIG. 40 shows the steps whereby user manually adjusts the perceived orientation and position of a product as displayed by a slave.

FIG. 41 shows the steps whereby the apparent orientation of a product to a user as displayed by a slave is controlled by user adjustments to the physical orientation of a master.

FIG. 42 shows the steps whereby user gestures with a master initiate actions related to control of a slave.

FIG. 43 shows the steps whereby a leader shopper passes control of viewing of a product to a follower.

FIG. 44 shows a data communication diagram for transfer of leader status between shoppers.

FIG. 45A shows a system whereby masters and other entities report shopping and transaction events to an administration server.

FIG. 45B shows a process whereby shopping events within the master and slave are correlated with transaction events by an administrator.

FIG. 46 shows a modified step 10-9 that determines a contribution to retail performance from an entity.

### SYSTEM OF THE INVENTION

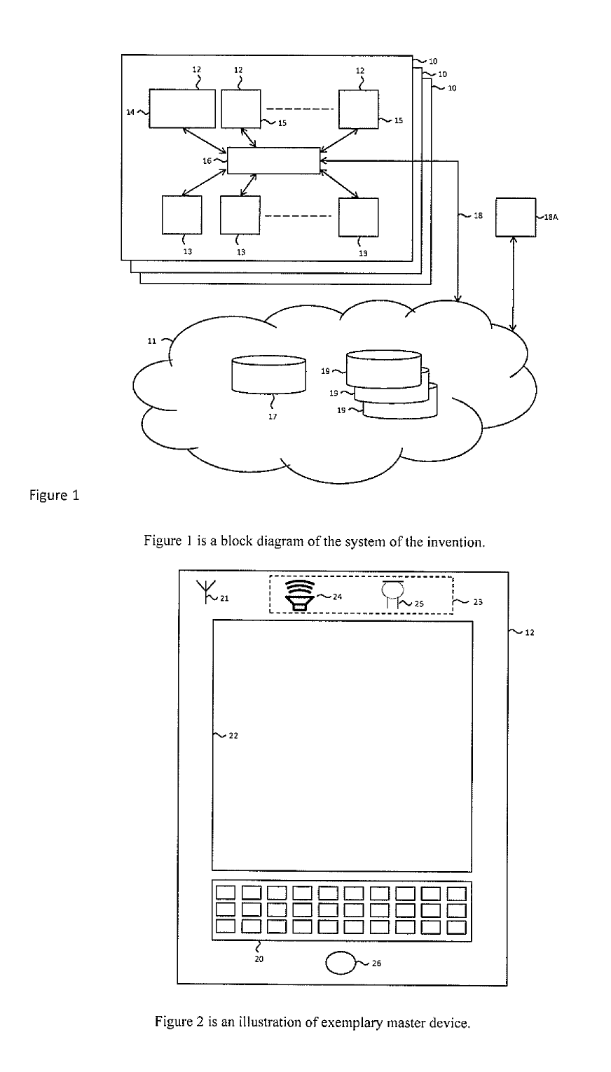

FIG. 1 shows a system of the invention that comprises one or a plurality of home or office local area networks (LANs) 10 connected to the Internet 11. Each LAN may comprise one or a plurality of routers or hubs 16 and employ wired (e.g. Ethernet, mains such as defined by the Homeplug Power Alliance) or wireless (e.g. as defined by IEEE 802.11, Bluetooth, Zigbee standards) methods.

Each location 10 is connected via a gateway or router 18 to the Internet and contains two classes of networked device: master devices 12 and slave devices 13. One or a plurality of master devices 14 within LAN 10 may be assigned to administrators. Similarly, one or a plurality of master devices 15 within LAN 10 may be assigned to users. An administrator's master device 14 and a user's master device 15 may be collocated in a common device. All devices may enter into bi-directional communication with entities in the Internet 11.

Preferably masters 12 are connected to LAN 10 via router 16 using wireless means such as Wi-Fi (IEEE 802.11) or Bluetooth. Similarly, slave 13 may be connected to LAN 10 wirelessly. Masters 12 and slaves 13 may be connected wirelessly via public mobile telecommunications base stations 18A and wireless wide area networks (WANs) to Internet 11. Master and slave devices contain computers which execute applications to perform the steps of this invention. The applications are installed by the user to the device from a third party in the Internet or alternatively an application or a portion of it may be pre-installed into the master or slave devices during manufacture. Master 12 and slave 13 may communicate with an administration server 17 and one or a plurality of retail servers 19 via the Internet 11.

### Master Devices

FIG. 2 shows master 12 which is preferably hand held and battery powered. Examples of masters 12 include smart phones (e.g. Apple's iPhones and Android phones), tablet computers (e.g. Apple's iPad and Samsung's Galaxy Tab) and laptop personal computers (e.g. using Windows 7 or Mac OS). Master's computer may communicate across WAN or LAN using a wireless transceiver 21, output graphics to an attached screen 22 which may be touch sensitive and receive user input from an arrangement of keys 20 and a home key 26 that causes the application in focus to a user to exit or suspend. Master may have a bi-directional, near field transceiver 23 comprising a data transmitting device 24 and a data receiving device 25.

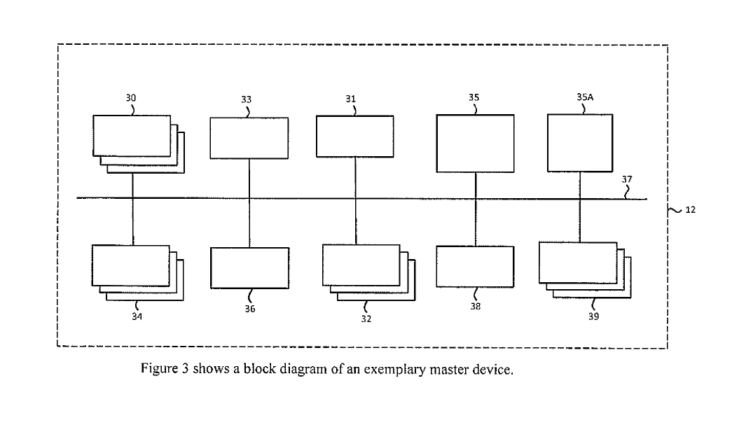

FIG. 3 is a block diagram of the functions within an exemplary master 12 which in the embodiment described is a Samsung Galaxy Tab tablet computer containing a 1 GHz ARM Cortex Exynos core microprocessor unit with supporting circuitry including real-time clock and timer 30, a PowerVR SGX540 graphics display processor with OpenGL 2.0ES compatibility to accelerate rendering of three dimensional (3D) graphics coupled to a 10.1 inch 1280×800 pixels colour LCD panel 31, 512 MByte volatile DRAM (dynamic random access memory) and 2 Gbyte non-volatile NAND flash memory 33, IEEE802.11n and Bluetooth wireless network adaptor 34, input devices (e.g. screen 32, keys 20 and 26) 32, speaker and microphone 35 arranged to operate as near field transceiver 36, coupled via a data bus 37.

Master 12 contains sensors 39 to measure its physical orientation and acceleration in three dimensions via Hall effect magnetometer, gyroscopic and micro-electromechanical system (MEMS) devices that are software controllable via application programming interface (API) frameworks (e.g. SensorManager and related classes for Android, or iOS CoreMotion for Apple iPhone and iPad) in common use in smart phones and tablets. Non-volatile portion of memory 33 is programmed to contain firmware for the software sub-system 38 which is loaded into volatile portion of memory 33 on power up. Master 12 may contain a haptic transducer 35A such as a buzzer or vibrator which can be sensed by user when held or touched.

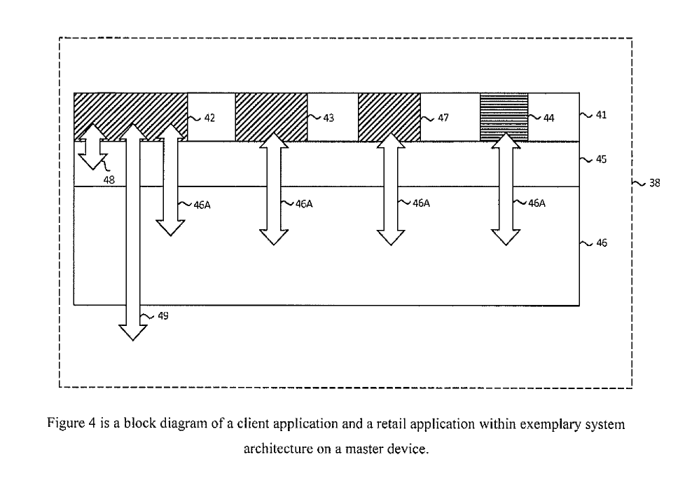

FIG. 4 shows how masters 12 may incorporate standard software and operating system architectures 38 such as the Android System Architecture familiar to persons skilled in software development for PNDs. The control processes described are implemented within a layer 41 of applications that include a master client application 42 that interoperates with one or a plurality of retail applications 43 that cause display of product information on master screen 22 and other or same content on a slave's screen as described later. A product is any tangible item (e.g. bicycle), content (e.g. book, movie), information (e.g. weather forecast) or service (e.g. financial loan, cleaning) available for transaction (e.g. sale, hire or lease) with a shopper. Examples of retail applications 43 include applications that display a catalogue of products on master screen and illustrate the product with photographs, animations and video clips on a slave screen. Retail applications 43 allow shopping users (shoppers) to transact with retail servers 19 over the products displayed (referred to later as “transaction events” where the secure functionality within retail application 43 to perform transaction events is well known to persons skilled in the field and not taught here). Applications are available to users to download to masters via applications and content services such as Apple's App Store or Google's Play Store, and where their application programming interfaces are public and familiar to application developers.

Retail application 43, one or a plurality of remote slave control applications 47 (e.g. one application 47 for each model of slave 13 attached to LAN 10 or, alternatively, a single universal remote control application for operation with all types of slave) and additional applications such as a browser 44 are layered over the Android Application Framework 45, and operating system 46 comprising libraries, Linux kernel and device drivers and capable of inter-application (or “inter-process”) communication via standard methods 46A (e.g. message queues, pipelines, semaphores, network sockets and Zeroconf service discovery to allow devices and applications to find each other on a LAN) provided by the Linux kernel and other operating systems 46. Operating system 46 maintains a file system in memory 33. Master client application 42 is abstracted from the hardware and link layers and has bidirectional intra-device 48 and inter-device 49 data communications via the layered architecture 45 and 46. Client application 42 forwards universal resource locations (URLs or “links”) to master client application 42 as inter-process communications 46A via Linux kernel 46. Master client application or daemon 42 is booted and started immediately each time master 12 is powered up and reloads the certificates (described later) from non-volatile memory so as to be available to retail application 43. Retail application 43 is adapted to receive inputs from keys 20 and screen 22, and adapted to receive inputs from key and screen inputs from remote users on LAN or WAN where the processes of remote key entry (e.g. such as the open source rdesktop client application) are broadly available to and understood by skilled persons. Master client 42 and retail application 43 may comprise audio conferencing functionality accessing the open Session Initiation Protocol (SIP) functionality within operating system 46 to support audio conference calls, and text chat sessions using the open Extensible Messaging and Presence Protocol (XMPP), between masters when they are distributed across a WAN. Alternatively, users may install and use a separate conference client (e.g. Skype, WhatsApp) in application layer 41.

### Slave Devices

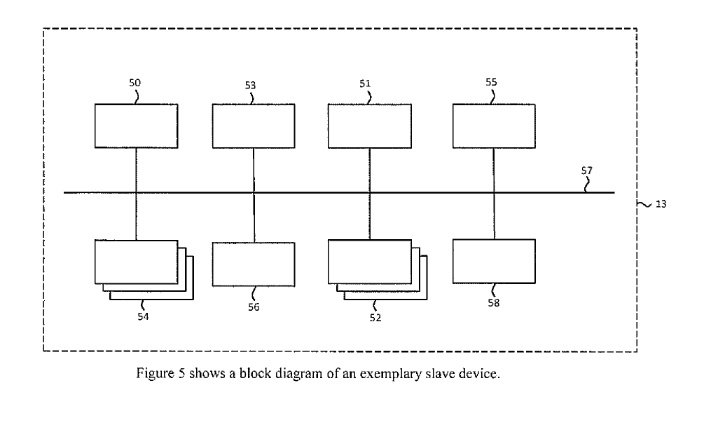

FIG. 5 is a block diagram of the functions within an exemplary slave 13 which in the embodiment described is a TV containing an STMicroelectronics “Freeman” FLI7525 ARM Cortex based audio video decoder comprising computer processor 50 and OpenGL 2.0ES display processor with three dimensional polygon rendering coupled to a 50″ inch 1920×1080 pixels colour LCD panel with stereoscopic line-interleave display capability 51, 1 GByte volatile DRAM (dynamic random access memory) and 512 Mbyte non-volatile NAND flash memory 53, IEEE802.11n wireless network adaptor 54, loudspeaker and microphone 55 arranged to operate as near field transceiver 56 coupled via a data bus 57. Non-volatile portion of memory 53 is programmed to contain firmware for the software sub-system 58 which is loaded into volatile portion of memory 53 on power up.

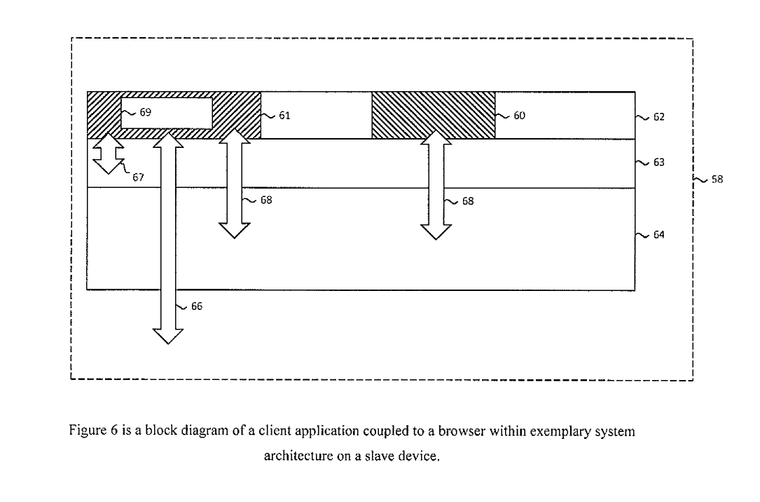

FIG. 6 shows the embodiment described, where slaves 13 incorporate the Android System Architecture 58 including WebKit browser and Chrome V8 JavaScript engine 60. Depending on the type of slave hardware, many other software architectures 58 are possible including Microsoft Windows, Apple iOS, MacOS and many embedded operating system middleware frameworks. Preferably, browser 60 is adapted to support the public CE-HTML and European Hybrid Broadcast Broadband TV (HbbTV) browser specifications so as to render HTML pages (or “scenes”) to TV screens predictably. Preferably, browser 60 contains a WebGL (Web Graphics Library) so as to render three dimensional objects via an OpenGL ES graphics processor unit (GPU) embedded in display processor 51. Retailer may be a video-on-demand vendor where products are TV programmes, such as movies, and where browser 60 is an application adapted to play a video streamed from retail server 19.

The control processes described are implemented by a slave client application or library or daemon (e.g. a background process) 61 interoperating with browser application 60 within application layer 62 over the Android Application Framework 63 and Linux kernel operating system (including libraries, device drivers and Zeroconf) 64. Slave client 61 is abstracted from the hardware and link-layers via bidirectional intra-device 67 and inter-device 66 data communications via the layered architecture 63 and 64. Preferably, slave client 61 embeds a low memory web server (such as the open source Mongoose program) as a representational state transfer (REST) server 69 for the purpose of receiving, processing and responding to requests from masters using the hypertext transfer protocol (HTTP). Slave client 61 starts browser 60 if not already running and forwards universal resource location (URL) references to browser 60 as inter-process communications 68 via Linux kernel 64. Slave client or daemon 61 is booted immediately each time the slave is powered up and reloads administrators signature (to be described later) from non-volatile memory so as to be available to master client 42.

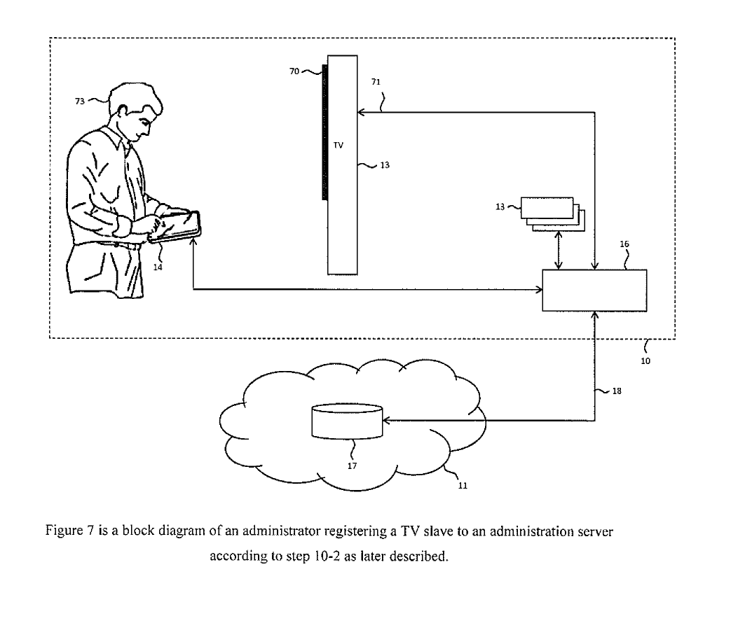

Slave device 13 is preferably a TV adapted to play audio and video on a relatively large screen visible simultaneously to multiple viewers. Alternatively, slave device 13 may be a personal computer coupled to a display monitor. FIG. 7 shows a typical home location 10 where the slave is a TV or a TV projection system 13 with screen 70 and coupled 71 to a LAN 10.

There are two types of operators of the masters and slaves: administrators 73 and other normal users. Administrators 73 may, in addition to normal users, confer access certificates to other users according to processes described later.

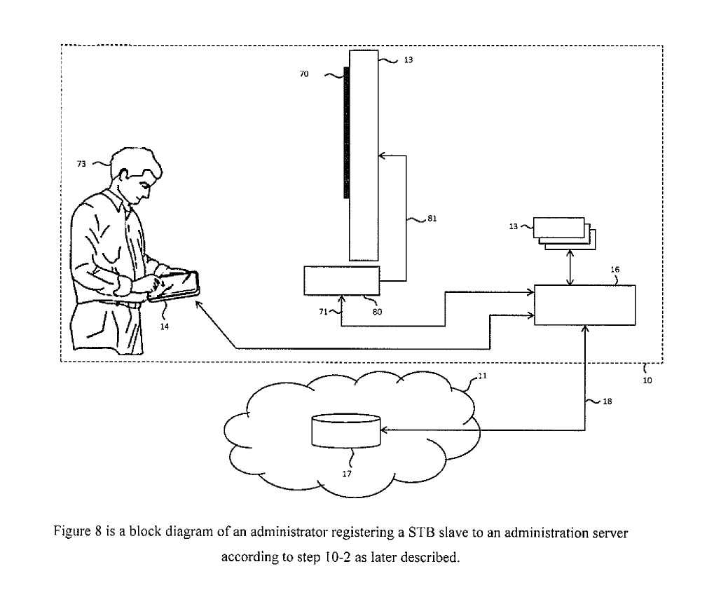

Slave 13 may comprise a set-top-box (STB) 80 (e.g. a decoder for playing over-the-top (OTT) content streamed from a media server over the Internet 11, a games console or a Blu-ray disc player) and TV coupled by an HDMI, SCART or other media cable 81 as shown in FIG. 8. Slave may be any networked computer device operable to render multimedia (e.g. text, graphics and video) content for display to a built-in or external screen that may be viewed simultaneously by multiple persons, such as a tablet computer (e.g. Apple iPad, Amazon Fire), a personal desktop computer or a laptop computer. Slave may be connected to LAN 10 and to administration server 17 via the Internet.

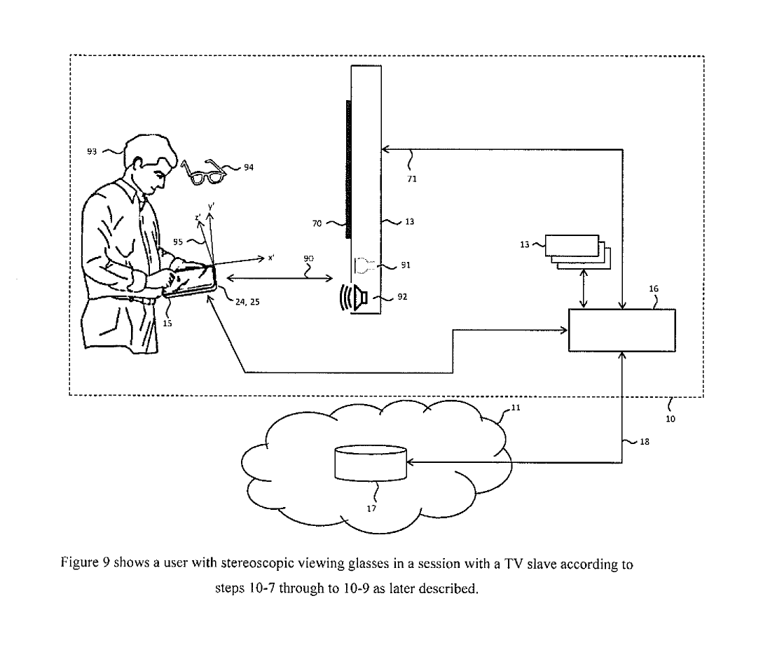

FIG. 9 shows a user's master 15 and slave 13 adapted to communicate over a short range of a few metres in a near field bi-directional link 90 with each other through use of a slave data receiver 91 coupled to master's transmitter 24, and a slave transmitter 92 coupled to master's receiver 25. User 93 may wear stereoscopic “3D” glasses 94 for viewing of objects rendered to display 70 for viewing in three dimensions. In the embodiments described, the near field transmission method is acoustic where transmitting components 92 and 24 are loudspeakers and receiving components 91 and 25 are microphones where digital signal processing is used to embed a short data message within audio content and to recover it using methods known to skilled users (Cana et al, 2002). In alternative embodiments, the near field acoustic transmission may be in the inaudible ultrasonic 20 kHz to 50 kHz frequency range. Alternative arrangements for transmitter components 92 and 24 may comprise functionality to enable their respective host's built-in screen devices 22 and 70 to display data in formats such as barcodes or smart posters according to formats such as published by the Near Field Communication (NFC) Forum, and where receiving components 91 and 25 are instead cameras adapted to receive and decode the same. In yet other embodiments, devices 91, 92, 25 and 24 may employ wireless data transmission methods such as Bluetooth, contactless card communication (e.g. ISO/IEC 14443 and FeliCa), infra-red (e.g. IrDA), RFID, wireless network (e.g. IEEE802.11a/b/g/n) or ZigBee.

### Process of the Invention

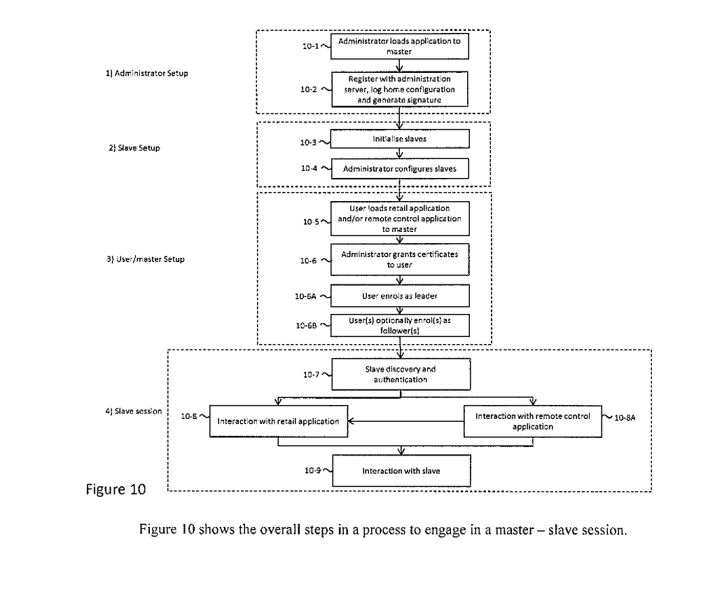

Referring to FIG. 10 the process of the invention divides into four phases:

1) Administrator Set-up comprises:
a. loading and initialisation of administrator's master client application 42 (step 10-1);
b. registration of home configuration with administration server and generation of a signature to be applied in the later phases (step 10-2);
   2) Slave Set-up comprises:
a. initialisation of slaves (step 10-3);
b. configuring slaves to hold the administrator's signature and access the network (step 10-4);
   3) User Set-up comprises:
a. user loading master client application to his/her master (step 10-5);
b. grant of administrator's master grants certificates to users' masters (step 10-6);
c. a first user starts a retail application as a leader (step 10-6A);
d. optionally, one or a plurality of users may start their retail applications to become followers (step 10-6B);
   4) Slave session comprises:
a. discovery of and authentication with a slave (“pairing”) (step 10-7);
b. operation of a retail (step 10-8) or remote control application (step 10-8A) on a user's master;
c. interaction between master and slave (step 10-9).

Each phase is described below.

### Initialisation of Administrator's Master Client: Step 10-1

Master client 42 is loaded to administrator's master 14 (e.g. by downloading from Google Play in the case of Android tablets or smart phones or pre-installing the application in the factory).

### Registration: Step 10-2

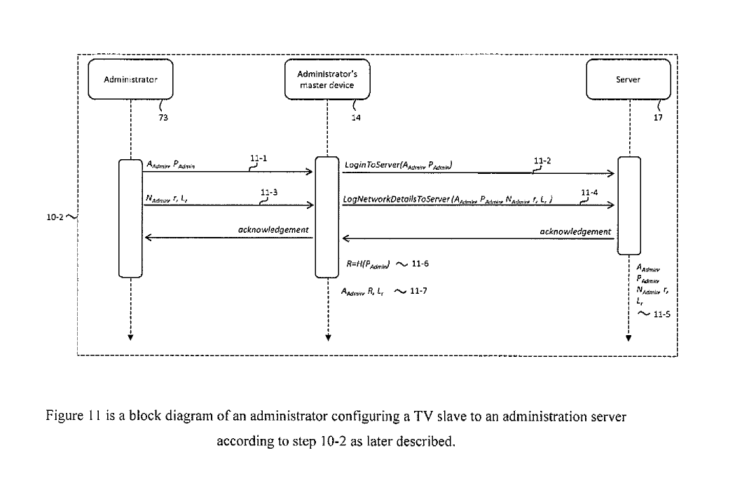

At least one user is an administrator 73 of a master 14, slaves 13 and LAN 10. The administrator registers his/her details with administration server 17 via his/her master 14 or another networked device (e.g. personal computer). FIG. 11 shows the interactions between administrator 73, master 14 and administration server 17 in more detail. Administrator 73 keys his/her personal account name A_{Admin}, password P_{Admin}, LAN 10 name, description and comments N_{Admin}, and access keys Lᵣ, for each wireless network r (steps 11-1, 11-2, 11-3 and 11-4). Administration server stores A_{Admin}, P_{Admin}, N_{Admin} and Lᵣ in non-volatile memory for later reference (step 11-5).

Administrator configures the slaves to recognise certificates later presented to them by authorised users' masters in step 10-7 described later by initialising each slave with a signature, R, generated as a hash function H( ) of administrator's password P_{Admin} and where in this embodiment H( ) is the 128-bit MD2 algorithm published as RFC 1319.

Administrator's master 14 generates R and erases P_{Admin} (step 11-6) to prevent illicit recovery of P_{Admin} from master device if stolen. A_{Admin}, R and Lᵣ are stored in master 14 in non-volatile memory for later reference (step 11-7).

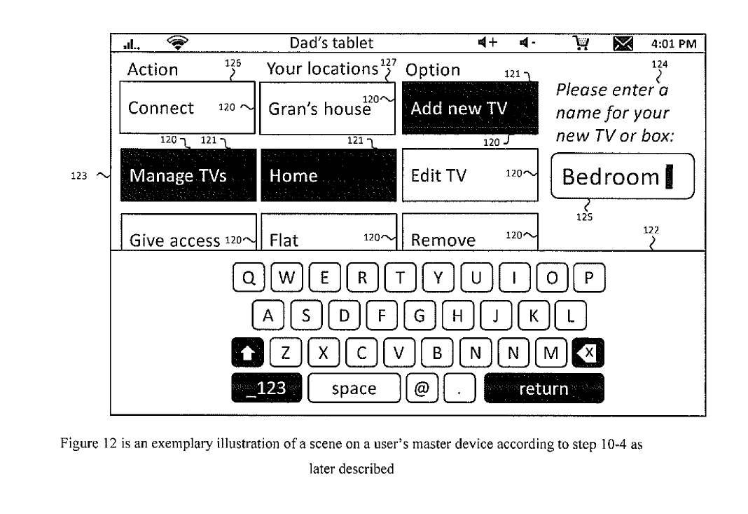

FIG. 12 shows how master client 42 displays information 123 to administrator via screen 22 during configuration process 10-2. In the embodiment described, master client application 42 receives touch selection from administrator of labelled cells 120 via screen 22 causing selected cells 121 to be marked or highlighted differently (shown as light text against dark fill in FIG. 12).

Master client 42 causes a soft keyboard 122 to be scrolled onto scene 123 when character values are to be input from administrator causing them to be displayed simultaneously in a labelled 124 non-touch sensitive cell 125 and keyboard 122 is withdrawn when a delimiting key such as return is touched.

Administrator may periodically repeat step 10-2 throughout the process of this invention to maintain configuration details.

### Initialising Slaves: Step 10-3

Where slave client 61 was not pre-loaded to the slave 13 in factory by the manufacturer, administrator 73 prepares the slave 13 by loading slave client 61 (e.g. by downloading from Google Play Store in the case of Android TVs and set-top-boxes).

### Configuring Slaves: Step 10-4

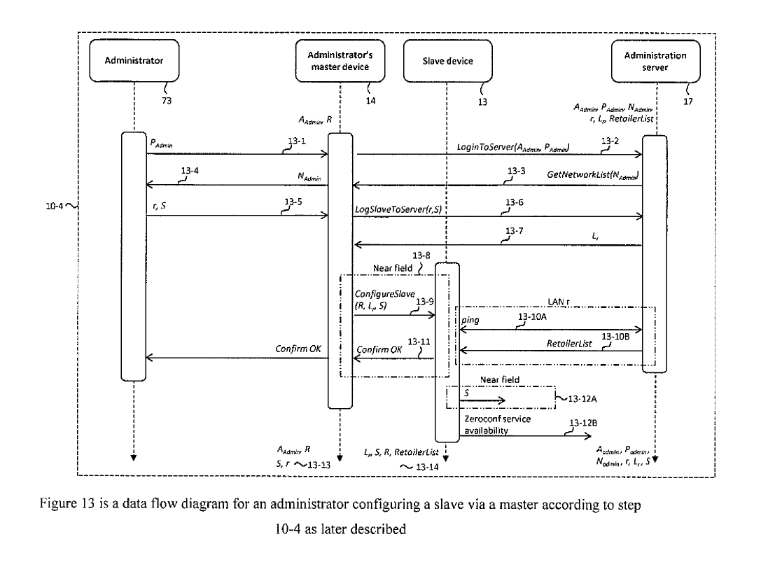

Administrator configures each slave according to step 10-4 whose sub steps are shown in FIG. 13 and described as follows. Administrator logs onto administration server 17 via his/her master 14 to enter his/her account name A_{Admin} and P_{Admin} (steps 13-1 and 13-2). Administration server sends to administrator the list of current networks N_{Admin} (steps 13-3 and 13-4). Master client displays a column list of action options 126 which includes an option to pair to slave (shown as “Connect” in example of FIG. 12), an option to grant certificates (shown as “Give access” in figure) according to step 10-6 to be described later, and an option (shown as “Manage TVs” in figure) to configure slaves according to this step 10-4 currently described. Master client 42 displays the list of network names in column 127 and detects administrator's selection of a particular network (shown as “Home” in example of FIG. 12) r, from the list. Client 42 receives a further selection from administrator to configure a new slave (shown as “Add new TV” in figure) whereupon administrator is prompted 124 and enters a particular slave's 13 name, S, via soft keyboard 122 or keys 20 (step 13-5). S is a unique text LAN host name referenced by addressing devices to resolve a device's internet protocol (IP) address. r and S are backed up from slave to administration server (step 13-6).

Administration server additionally returns the access information Lᵣ for network r to master 14 (step 13-7). Slave is continuously in a receive state to detect near field commands from masters 12 (step 13-8) and is adapted to be configured from an administrator's master 14 directly as follows. Master 14 broadcasts in near field a command, ConfigureSlave, with argument values for hash key R, network access details Lᵣ and slave identifier S in near field (step 13-9). Slave 13 receives and decodes the near field broadcast from master 14 to recover the command and arguments ConfigureSlave (R, Lᵣ, S). Slave 13 may determine whether it has been previously configured with different argument values Lᵣ, S and, if so, displays a warning to administrator. Slave attaches to LAN 10 using access details Lᵣ via application framework 63 and verifies that it can ping administration server 17 (step 13-10A). Slave uploads from administration server 17 via LAN 10 and Internet 11 a list of identities of retailers, RetailerList, for which user session processes 10-9 are later to be permitted (step 13-10B). In the embodiment described RetailerList is a text list of numeric identifiers, RetailerID, of each retailer or retail application 43. In other embodiments RetailerList may contain authentication details for each permitted retailer which slave client application 61 uses to authenticate the retail application 43 during the later user session processes 10-9. Slave client saves RetailerList to non-volatile memory so that it can later be referenced during subsequent user sessions 10-9. In other embodiments, slave may periodically download updated versions of RetailerList from administration server 17, e.g. every day or every week, so as to permit user sessions with new versions of retail application 43. Slave confirms to administrator via master that it is successfully configured (step 13-11). Thereafter, slave broadcasts its availability continuously and repetitively every few seconds its host name S in near field proximity (step 13-12A) and its availability as a Zeroconf service on LAN 10 (step 13-12B) throughout its remaining operation. Administrator's master stores S and r to non-volatile memory for reference when administrator grants a user certificate as described later (step 13-13). Lᵣ, R and S are written to non-volatile memory in slave 13 for reference when paired with a user's master device as described later (step 13-14). Circumstances may arise where either a master or slave is not adapted for near field communication. In such cases, steps 13-8, 13-9 and 13-11 may be replaced by an administrator manually keying R, Lᵣ and S into slave as a menu setting using a conventional infrared RCU.

Step 10-4 may be repeated so that a plurality of slaves are configured by exchanging administrator's signature R and slave identifiers S with administrator's master 14 and/or administration server 17.

### User Loads Applications to Master: Step 10-5

User loads master client 42, retail application 43 and remote control application 47 to his/her master 15 as described previously for administrator's master 14 in step 10-1.

### Administrator Grants Certificates to User: Step 10-6

In this step administrator confers certificates on users to allow them to control particular slaves that administrator configured previously in step 10-4. A certificate signature Q is transferred from administrator's master to user's master. In the embodiment described, Q is a 16 byte word calculated as a hash function H( ) of three components: S, M_{User} and R.

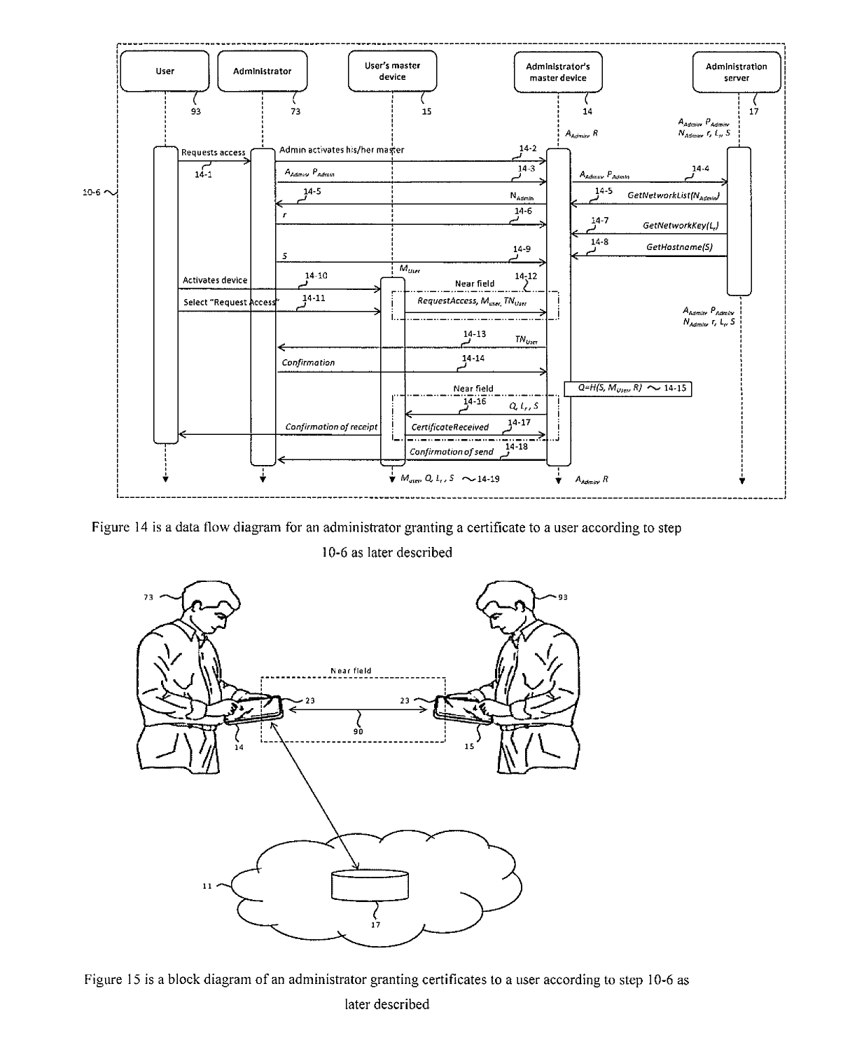

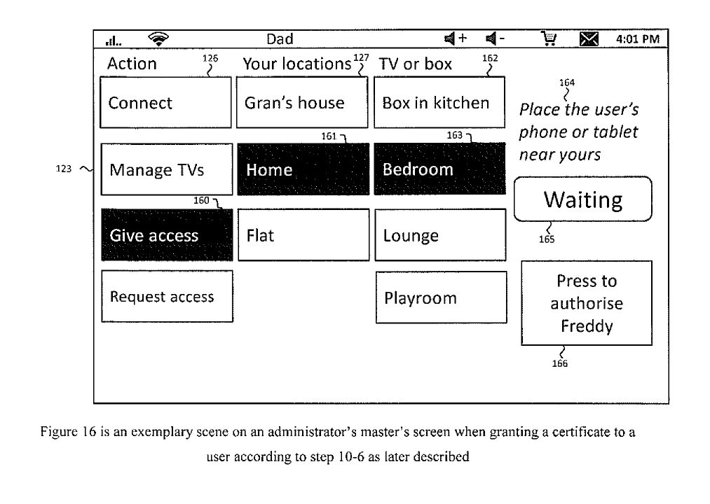

FIG. 14 shows the sub-steps for granting the certificate, and is described as follows. Administrator 73 cooperates with a request from another user 93 for a certificate (step 14-1) and places transceiver 23 on his/her master 14 in a near field link 90 with transceiver 23 of other user's master 15, shown in FIG. 15. If required administrator wakes his/her master 14 from standby and starts client application 42 in master 14 (step 14-2). Administrator logs into administration server 17 with his/her account name and password (steps 14-3 and 14-4) via his/her master and selects a cell whose action corresponds to granting of a certificate (e.g. cell 160 labelled “Give access” in example of FIG. 16). Administrator's master fetches the network list, N_{Admin}, from the administration server and lists the network names to column 127 on master's 14 screen 22 (step 14-5). Administrator selects a cell 161 corresponding to a desired LAN r, to which access is to be given to user 93 (labelled “Home” in FIG. 16) (step 14-6) causing master client 42 to upload the network access key Lᵣ if required (step 14-7) and host names of slave S previously registered to LAN r during step 13-6 from administration server (14-8 respectively). Administrator's master client 42 lists the slave names, S, to column 162 for selection of the desired slave 163 (labelled “Bedroom” in example of FIG. 16) for which a certificate is to be granted (step 14-9). Administrator's master displays instructions for administrator 164 and a cell 165 to indicate the status of communication of certificate, Q, across link 90.

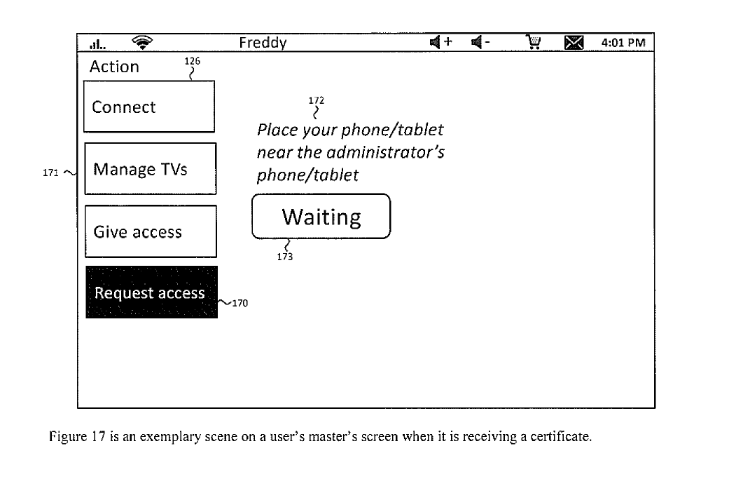

If required other user 93 wakes his/her master 15 from standby and starts master client 42 (step 14-10). FIG. 17 shows exemplary scene 171 generated by master client 42 of other user's 93 master 15. User 93 selects an action 170 from a column list of actions 126 that corresponds to a request for access (step 14-11) and follows instructions 172. User's master 15 displays a cell 173 denoting status of link 90 and transmits a data token corresponding to a request for access RequestAccess, its unique numeric identifier M_{User}, user's master's text hostname TN_{User}, (e.g. “Freddy”) several times per second in a data stream to master 14 in near field (step 14-12). Administrator's master 14 captures M_{User}, TN_{User} and displays instructions in cell 166 for administrator 93 to select to authorise transfer of certificate (labelled “Press to authorise Freddy” in example of FIG. 16) (step 14-13). Administrator confirms TN_{User} by touching cell 166 (step 14-14) causing master client 42 in administrator's master 14 to calculate signature Q=H(S, M_{User}, R) (step 14-15). Q and Lᵣ (if required for LAN r) are transmitted to user's master device 15 (step 14-16) and stored in its non-volatile memory 33 (step 14-19). User's master updates cell 173 to indicate that a certificate has been received (e.g. by displaying “Received”) and returns a token, CertificateReceived, to administrator's master to confirm receipt of certificate (step 14-17). Administrator's master updates cell 165 to confirm that the certificate has been successfully sent and received by user (e.g. by displaying “Sent”) and clears cell 166 (step 14-18).

Circumstances may arise where either administrator's or other user's master is not adapted for near field communication. In such cases, steps 14-12 to 14-16 may be replaced by master 15 client 42 transferring M_{User}, TN_{User} to administrator master 14 client 42 across the LAN and/or WAN to administration server 17, for administrator master client 42 to calculate Q according to step 14-15 and return Q, Lᵣ and S to other user's master 15 via same route.

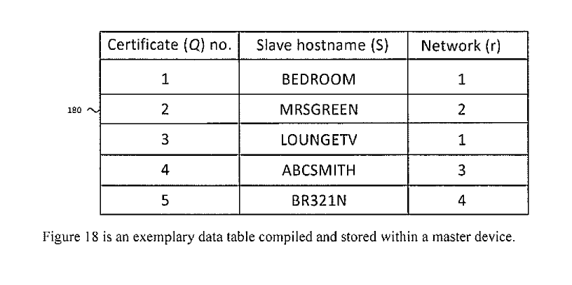

Step 10-6 may be repeated so that a user's master 15 may accumulate a plurality of certificates and network access details, L, in non-volatile memory for particular slaves, S, under one or more administrators' control. Referring to FIG. 18, user's master client 42 adds a new record for the acquired certificate to a table 180 stored in masters' non-volatile memory 33 each time step 10-6 is followed. Each record contains an index to the acquired certificate Q, the host name S for the slave with which the certificate is associated and the index r to the LAN 10 in which the slave is located. In the example of FIG. 18, the first record refers to a certificate number “1” associated with a slave whose host name is “BEDROOM” on a LAN whose access details are L₁ which is host also to another slave “LOUNGETV”.

### Users Become Leader or Follower: Step 10-6A

Users 93 of a common mutually interoperable retail application 43 (i.e. retail applications 43 may be of different builds or variants, or operate on different operating systems or hardware) are referred to as “shoppers”. A “group” means one or a plurality of shoppers that each collaborate using a master device to view items in a live session where interactions between shoppers are in real time while they view product items. Shopper members of the group may be localised (e.g. shopping together in the same room across a LAN), geographically dispersed (e.g. across a WAN) or some combination. A group contains a single “leader” shopper and optionally one or more “follower” shoppers. Shoppers each engage in a session with their masters 15 and retail applications 43 which acquire either leader or follower status, and may swap status during the session. A leader without any follower is referred to as a “lone” shopper. The leader makes product selections viewed in real-time by both leader and followers, if present. Retail application 43 may acquire either a leader 43A or follower 43B status as described later. Both leader and followers may buy the item using their retail applications 43A and 43B.

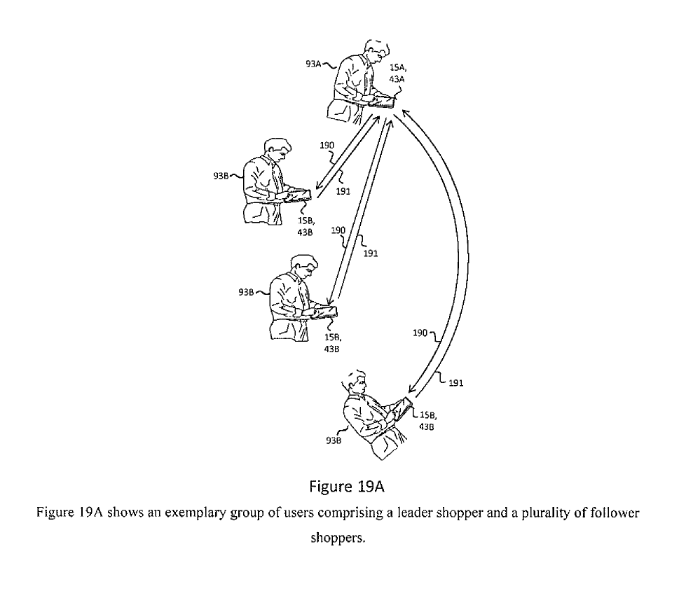

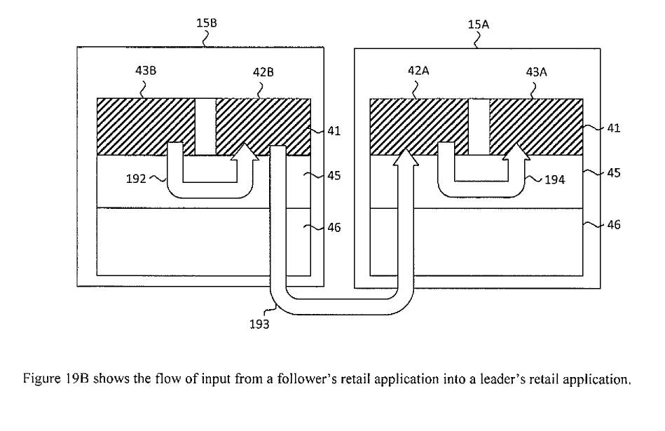

FIG. 19A shows a session where leader 93A uses a master 15A and a retail application 43A, and is accompanied by followers 93B using masters 15B and retail applications 43B. Each leader retail application 43A broadcasts regularly (once per second) across LAN 10 or WAN details of its master 15A host name and the host names of the masters 15B whose retail applications 43B are currently following it. Leader retail application 43A generates display message events 190 (e.g. a URL or XML file) to update leader master's 15B local display and also for broadcast to remote follower applications to cause updating of their remote displays. Follower may make inputs 191 to the leader retail application 43A via inputs to his/her retail application 43B via keys 20 or screen 22 on his/her master 15B subject to stored preferences (e.g. “Do not accept inputs from other shoppers”) a leader may have expressed to retail application 43 previous to accepting shoppers (see step 20-11 described later). In the case where a group is distributed across the Internet or across a WAN, administration server 17 support master client applications 42A and 42B with an IP address exchange service where retail applications 43A and 43B may exchange events 190 and 191 as either multiple unicast streams or explicit multi-unicast (Xcast) methods to reduce bandwidth.

FIG. 19B shows the flow of screen events 191 through the software layers for a follower's master 15B to the leader's master 15A. Follower creates key and screen input events 191 that flow as an inter-process communication from the follower retailer application 43B through follower master client application 42B across the LAN 193 through leader's client application 42A to control leader retail application 43A according to the same process as if they are input by leader locally. Conversely the same path is taken in the opposite direction for display events 190 generated by the leader retail application 43A.

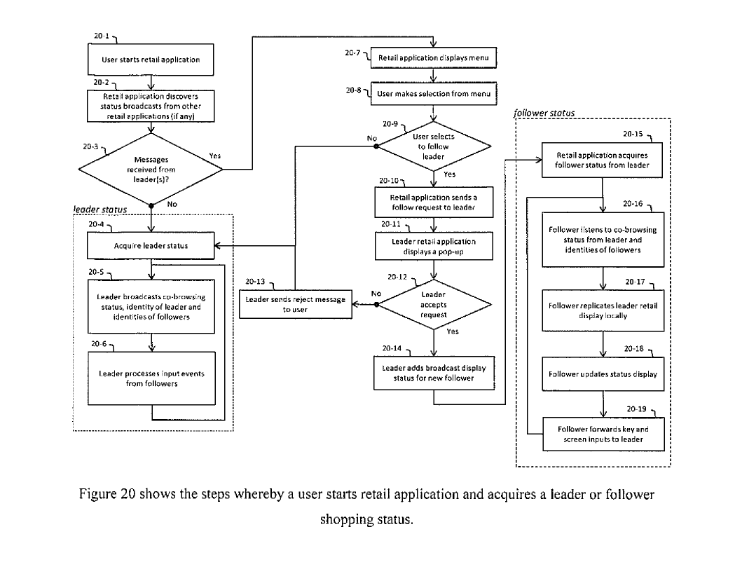

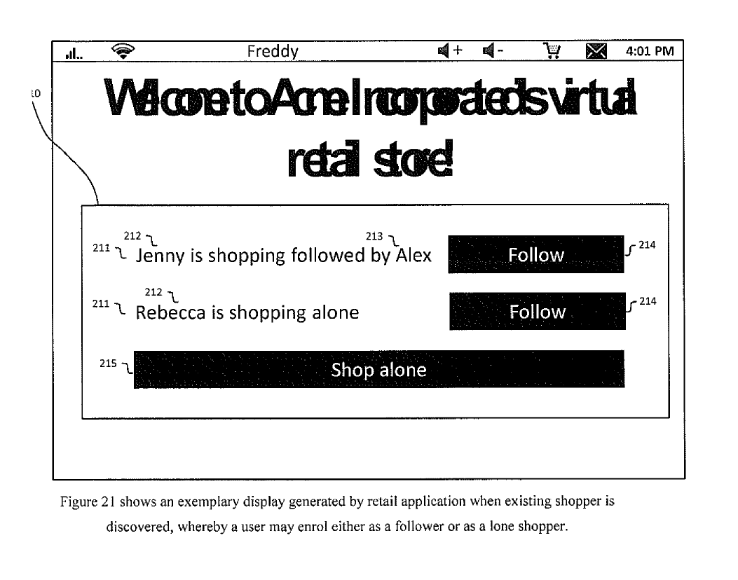

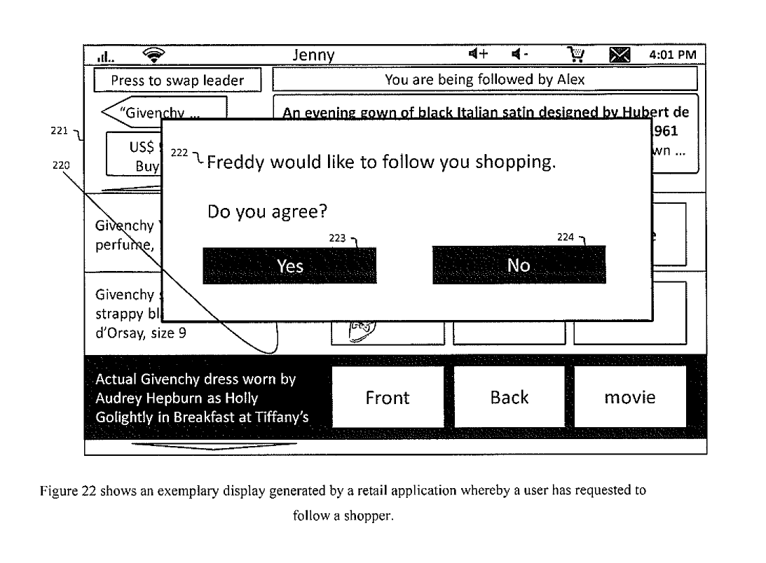

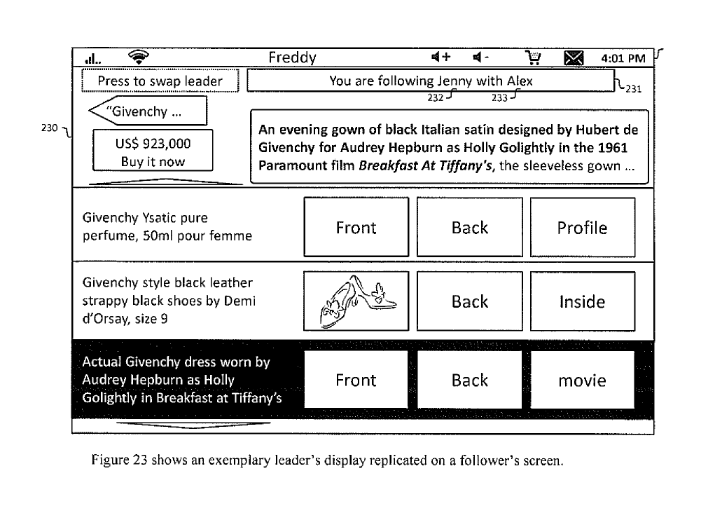

FIG. 20 shows the process whereby a shopping group may be formed or modified. User 93 acquires leader or follower shopping status, described as follows. A user 93 starts retail application 43 or brings it to focus on screen (step 20-1). Retail application 43 listens for a period of a few seconds sufficient to receive and parse status broadcast messages from all retail applications 43 connected to LAN 10 (step 20-2). If no message is received (step 20-3), retail application 43 confers upon itself leader status 43A autonomously (step 20-4). Thereafter leader application 43A broadcasts regularly (e.g. once per second) on LAN 10 a message indicative of its leader status, together with leader shopping user's 93A text name TN_{User} and master's 15A host identity M_{User} and text name TN_{User} identities (M_{User}, TN_{User}) of each follower 93B, if any, that may have previously enrolled during steps 20-10 through to 20-14 to be described (step 20-5). Leader retail application 43A receives and processes screen and key events 191 from follower applications 43B. If broadcasts were received (step 20-3), retail application 43 displays a menu to allow user to follow a shopper according to their identities as parsed in step 20-2 (step 20-7) where an exemplary menu 210 is shown in FIG. 21 and described as follows. Menu 210 displays an entry 211 for each leader retail application 43A that broadcasts its status in step 20-5 where each entry 211 identifies the text name TN_{User} of the master 15A that is host to leader retail application 43A 212 (e.g. “Jenny” and “Rebecca” in FIG. 21). Each entry 211 lists the text name TN_{User} of each master 15B that is host, if any, to a follower retail application 43B, 213 (e.g. “Alex” in FIG. 21). Each entry 211 is marked with a cell 214 that user 93 may select to become a follower 93B to the leader 93A identified. Menu 210 contains a labelled cell 215 that user 93 may select to become a lone shopper 93A. User 93 makes a selection from menu 210 (step 20-8). If user elects to become a lone shopper by selecting cell 215 (step 20-9), then user acquires leader status 93A and retail application 43 executes steps 20-4 through 20-6 previously described. Otherwise, if user 93 selects a cell 214 according to leader name 212 (step 20-9) then retail application 43 sends a message to retail application 43A requesting permission to follow shopping selections entered by user/leader 93A (step 20-10). Leader's 93A retail application 43A generates a pop-up message 220 that may partially or fully overlay retail application 43A display 221 to invite leader 93A to indicate acceptance, as shown by FIG. 22 (step 20-11). Leader may have elected previously to accept follower requests automatically for convenience by adjusting a preference setting (e.g. “Select to accept shopper requests automatically”) for retail application 43. In which case step 20-11 is omitted. If leader 93A selects a cell 223 to accept (step 20-12), then leader retail application 43A adds the host name (“Freddy” in example of FIG. 21 and FIG. 22) of the newly acquired follower to its regular status broadcast (step 20-14) and retail application 43 clear acquires follower status 43B (step 20-15). Retail application 43B follows a continuous loop (until user 93B presses home key 26 to exit) whereby it polls for or listens to status broadcasts from leader retail application 43A containing all information 190 needed (e.g. product category identifier and/or product identifier, cell identifiers and highlight statuses) (step 20-16) for follower retail application 43B to replicate the display of leader retail application 43A on follower master's 15B screen 22 (step 20-17) as shown by 230 in FIG. 23. Inputs made to retail application 43A made by leader 93A that result in a change to the appearance of his/her display 221 are broadcast during step 20-5 to followers and an equivalent change is effected to the appearance of the majority (e.g. excluding status bar 234 and shopper status 231 described later) of the display 230 of each follower 93B during steps 20-16 through to 20-18.

In the embodiment described co-browsing methods (such as described in US patent publication U.S. Pat. No. 8,051,178) are employed to synchronise the content displayed by the leader's display and followers' displays at a product item level so as to display substantially the same but not necessarily identical details such as titles, descriptions and statuses of interactive areas (e.g. whether a cell is in focus, inputs to fields) relating to a product item. While retail applications 43 may each be displaying to different screen sizes 22 and orientations (e.g. portrait, landscape) the product information visible on each display is at least similar. In the embodiment described the reference and navigation information employed to obtain synchronisation during steps 20-5 and 20-16 through to 20-18 is a small (50 byte) XML format file specific to the retail application 43. Retail application 43 may be a browser where the co-browsing data transmitted to follower retail application to replicate display on shopper's screen includes a URL, data indicative of the portion of the content referred to by the URL that is visible on leader's screen 22 and data indicative of the portion of the content referred to by the URL that leader may have last touched on his/her screen. Retail application 43B updates periodically (every few seconds) a section 231 of display 230 to identify the leader's 93A identity 232 and the identities of followers 233 (step 20-18).

If leader 93A selects a cell 224 to reject at step 20-12, leader retail application 43A transmits a reject message to retail application 43 (step 20-13) causing it, its user 93 and master 15 to acquire lone statuses 43A, 93A and 15A through execution of steps 20-4 and 20-5 previously described.

### Communication Between Shoppers

One or a plurality of the masters may be located remotely from one or more of the other masters of the group. In such case, to allow group users to discuss their shopping experience, a voice-over-internet, speakerphone conference call is established between the masters of the group when they join the group (i.e. from step 24-12) according to processes well known to persons skilled in internet telephony.

Adding a Shopper into a Group by Bumping Master Devices Together

It is an object of the invention to allow shoppers to form and modify groups as quickly and simply as possible. An alternative method for adding a shopper as a follower to a group which does not require shoppers to view or key inputs into their screens (such as required by steps 20-8 and 20-11 previously) is described. The method employs detection of an event common to a pair of master devices (e.g. smart phones). In the embodiment described the event comprises a pair of masters bumped together in contact, where each master records the time of the event as occurring within a time G of the other. Other types of events common to a pair of masters in proximity are also possible, for example, an event where each master detects from the other a signal such as a gesture, not necessarily of the same type, and where each recognises the other's signal as occurring within a fixed period of its own. Other types of gestures (e.g. spoken words from user to master, bringing two masters in near field proximity of each other to permit a radio or acoustic communication, or a user shaking or tapping a master) may be employed. Different actions occur according to the statuses of the shoppers party to the event. Rules for interaction between shoppers considered to afford greatest benefit are described as follows:
1) an event between two leaders causes:
   a) their groups to merge (see steps 24-17 and 24-20 below), and;
   b) the leader which started his/her group the later to become a follower;
2) an event between a follower and leader of the same group causes the shoppers to swap their leader and follower statuses (see steps 24-16 and 24-21 below);
3) an event between a follower and leader of different groups causes the follower to follow the leader's group (i.e. the leader and follower statuses are not swapped) (see steps 24-17 and 24-23 below);
4) no action occurs when an event occurs between two followers (see step 24-14).

Rule 1 is useful because it allows lone shoppers to combine into a single group with a single action. Rule 2 is useful because it allows a follower to take the lead in a group with a single action. Rule 3 is useful because it allows a follower to join another group with a single action. It will be readily apparent that other rules are possible where, for example, an event common to two leaders may cause them instead to swap groups.

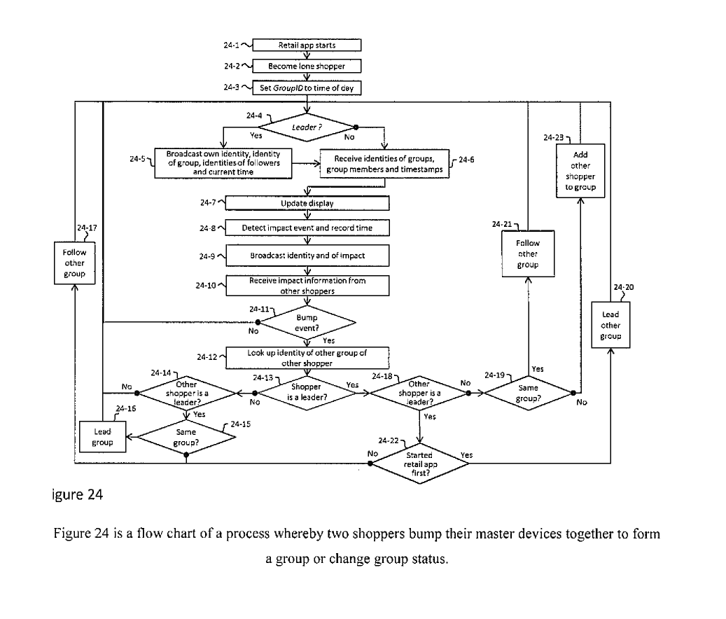

FIG. 24 shows a process whereby a group of shoppers may be formed or changed. Two shoppers interact according to the rules presented as follows. A user 93 starts his/her retail application 43 or brings it to focus on screen on master 15 (step 24-1). Retail application 43 acquires default status as a lone shopper (43A) (step-24-2) of a new group and seeds a unique integer identity for its group, GroupID, from the current time and date according to its real time clock 30 (step 24-3).

Retailer application 43 enters a continuous event loop from step 24-4 whereby, if it is a leader 43A (step 24-4), it repetitively broadcasts a group status message comprising its host and text name identity (M_{User}, TN_{User}), the current time (t_{Current}) according to its clock 30 and its group identity (GroupID) plus the host and text name identities M₁ . . . Mₙ of its followers (if any) on LAN 10 (step 24-5). Using the example of the leader “Jenny” referenced in FIG. 23, her broadcast message would appear (omitting the M_{User} fields) as:
“Jenny”, “2011021316014517”, “2011021315352946”, “Alex”, “Freddy”
   where the host “Jenny” reported the current time as 45.17 seconds past 1601 hrs, and GroupID acquired its identity from a time and date of 29.46 seconds past 1535 hrs, on 13^{th} Feb. 2011. Retailer application 43 receives messages broadcast during step 24-6 from other leader retailer applications (if any) and marks each with a time stamp using the current time t_{Stamp} according to its real time clock 30 (step 24-6). Retailer application 43 updates its display 231 with its status (i.e. whether it is a leader or follower) and the identities of the other members of its group (e.g. according to example of FIG. 23 earlier a follower of hostname “Freddy” and group “2011021315352946” would display “You are following Jenny with Alex”) (step 24-7). Retail application 43 detects whether an impact event has occurred by sampling audio microphone 25 or acceleration sensor 39 to detect a transient increase in intensity over background threshold intensity and records the time of impact, t_{Impact} (step 24-8). When an impact is detected, retail application broadcasts a message containing its identity, M_{User}, and t_{Impact} to all other retail applications 43 on LAN 10 (step 24-9). Retail application 43 simultaneously listens for messages of impact events from other retail applications and records the others' identities M′ and times of impact t′_{Impact} (step 24-10). Retail application applies a time correction (the difference between its measurement t_{Stamp} and the other shopper's reported time t′_{Current}) and determines that a bump event has occurred if the difference between the impact events is less than the tolerance time, G (typically 500 ms) as follows (step 24-11):

|(t_{Impact}−t_{Stamp})−(t′_{Impact}−t′_{Current})|<G

The event loop recycles at step 24-4 until a bump event is detected (step 24-11). When a bump is detected (step 24-11), retail application looks up the identity of the other group (GroupID′) from the host name M′ of the other shopper involved in the bump event from the other group status messages received in step 24-6 (step 24-12).

If retail application is a follower (step 24-13) and other retail application is also a follower, as determined by retail application from broadcast messages received during step 24-6, then event loop recycles at step 24-4 (step 24-14). If at step 24-14 the other retail application is determined to be a leader of another group (i.e. GroupID!=GroupID′) then the retail application acquires follower status and follows the group GroupID′ (steps 24-15 and 24-17) and recycles the event loop from step 24-4. Otherwise if the groups are the same (i.e. GroupID==GroupID′) (step 24-15) retail application becomes a leader (step 24-16).

If the retail application is a leader (step 24-13) and the other retail application is a follower (step 24-18) then retail application adds the other retail application as follower (step 24-23) if the groups are not the same (step 24-19). If the groups are the same (step 24-19), retail application follows the other group (GroupID′) (step 24-21) and the event loop recycles from step 24-4.

If both retail applications are leaders (steps 24-13 and 24-18) a tie breaker is applied in favour of the application which was started or brought into focus by its user first (step 24-22) as follows. If (GroupID−tₛₜₐₘₚ)<(GroupID′−t′_{Current}) then retail application acquires the members of the other group (GroupID′) by including its members (as determined at step 24-6) in GroupID (step 24-20) and recycles the event loop from step 24-4. Otherwise retail application follows the other group (GroupID′) (steps 24-17 and 24-18) and recycles the event loop from step 24-4.

An audio-conference or text chat link may be established between all members of a group responsive to new masters joining the group and, conversely, links are terminated with masters as they leave the group.

### Leader's Display

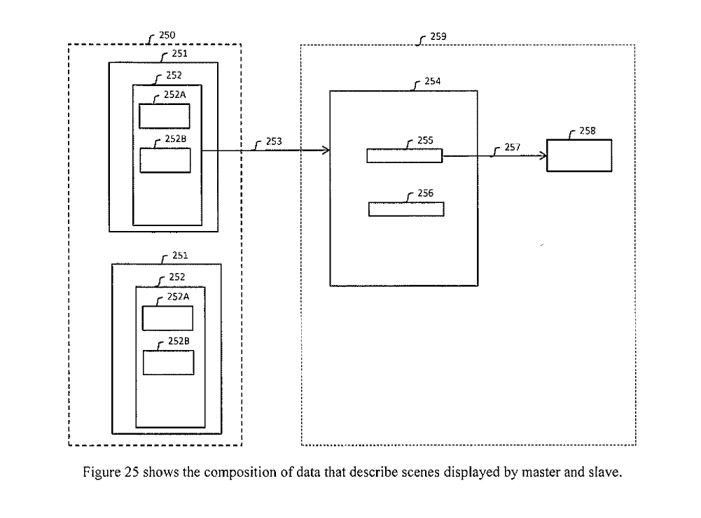

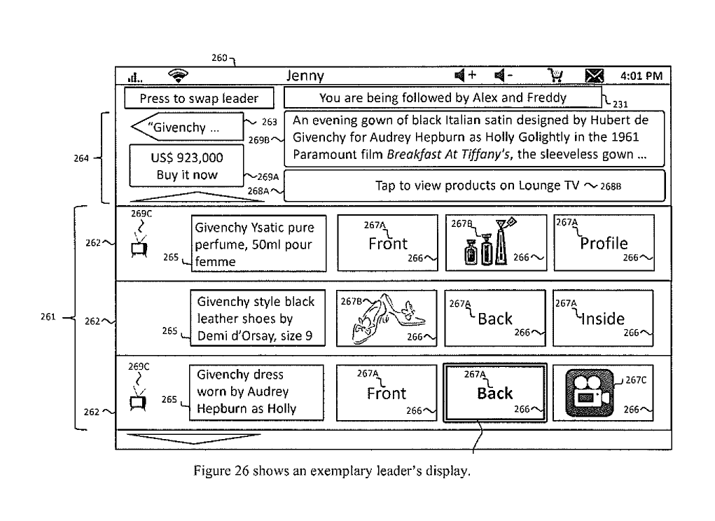

FIG. 25 shows the composition of data 250 that describe scenes 260 to be rendered and displayed by retail application 43A on master 15A, and by follower retail applications 43B on masters 15B. FIG. 26 shows an exemplary displayed scene 260 from a leader retail application 43A on master 15A.

Data 250 are typically in extended mark-up language (XML) or hypertext mark-up language (HTML) formats, and contain subsets 251 of data that each describe a product (rendered as a band 262 in scene 260). Each product subset 251 may contain one or a plurality of data subsets 252. Each subset 252 describes a cell 266 in band 262. Subset 252 may contain a link or URL reference 253 to data 259 to be rendered by slave browser 60 on screen 70 (to be described later) such as to data 254 that describes scene 370 to be displayed by browser 60 on display 70 (to be described later). Scene data 254 may contain sections 255 that contain downstream links or references 257 to other scenes 258 that user may select with browser 60. Data subset 252 may be embedded with identifiers 252B that characterise capabilities of slave browser 60 necessary to render the referenced data 254 with slave browser 60. For example certain URLs 253 may refer to data that can only be rendered by a browser with HbbTV, HTML5, WebGL and or video playing capabilities.

Area 261 contains a column list of one or a plurality of sub-areas or horizontal bands 262 that each represents a product item that satisfies a search word or phrase 263 in a second area 264. Each band 262 may display a name or descriptive note 265 and one or a plurality of cells 266 that contain or feature one or a combination of text 267A, photographs or illustrations 267B, or videos 267C. Each of cells 266 through to 267C may be frozen, animated, flashing or playing in any combination. Leader 93A may scroll band 262 horizontally to reveal other cells 266 by swiping band 262 by touch to left or right.

### Other Users Start Retail Application as Followers

One or a plurality of other users 93 may start retail application 43 subsequent to the leader (and while leader application 43 is continuing to execute) on their masters to become “followers” by default (shown as user and master labelled 93B and 15B in FIG. 19 respectively).

### Slave Session

Master devices are hand held with small screens that cannot display easily all information related to a product item simultaneously, cannot display items in detail, cannot play back high quality audio and cannot play audio or video in a form suitable for experience simultaneously by multiple members of a group. An important object of the invention is therefore to overcome these limitations by providing means for a master to effect a slave to play detail and visualizations supplemental to the particular item 262 viewed individually by the group members, on a large, fixed display (such as a large screen television) in a form easily visible to and audible by the whole group. A leader shopper 93A and master 15A may consequently initiate a control session with a slave according to steps 10-7, 10-8 and 10-9 to be described.

### Discovery and Authentication: Step 10-7

A master and slave are paired for a session when a master has discovered and authenticated itself to a slave. A master may contain certificates for multiple slaves and it is required therefore that master should, when requested by retail application 43A, select and authenticate itself with one of such slaves with a minimum of interaction from the leader 93A. To prevent a master inadvertently controlling a slave that its leader 93A cannot view (e.g. because the slave is in another room) it is required that a master should inform and present leader 93A with an option to use a slave for viewing a portion of the content displayed by retail application 43A conditionally upon a slave being in near proximity to the master. In the preferred embodiment, near field communication is employed to filter out slaves on the same LAN but out of proximity. A slave may be unavailable or occupied (e.g. because it is in a session with another user) and so it is required that master should engage a slave conditionally upon its availability. Master must determine a slave from a possible plurality of slaves 13 for which master contains certificates.

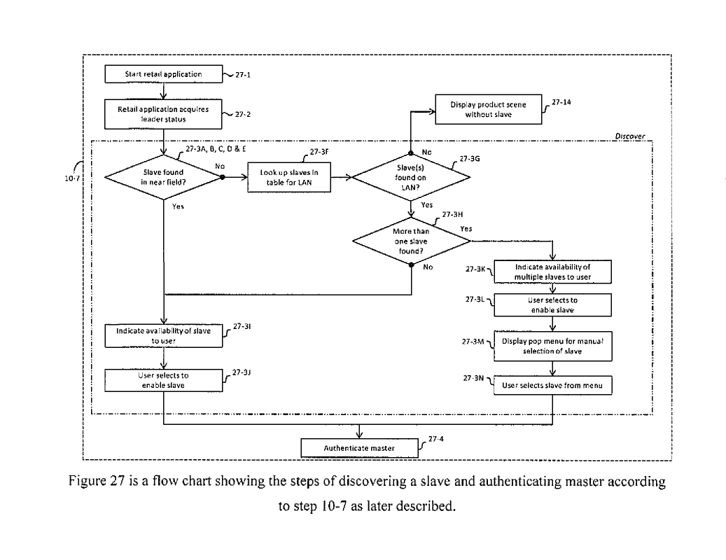

The flow chart of FIG. 27 shows the overall steps of discovery and authentication and is described as follows. User 93 starts retail application 43 to become leader 93A (step 27-1) so that retail application 43 acquires leader status 43A (step 27-2) as shown in FIG. 20 or FIG. 24 and already described. Retail application detects execution of master client application 42 (e.g. by filtering for the process name in the output of the Linux ps command). If client 42 is not found, retail application displays a message to inform that slave functionality is not available but may be installed for future sessions and continues without displaying the availability of a slave in cell 268A.

### Master Discovers Slave

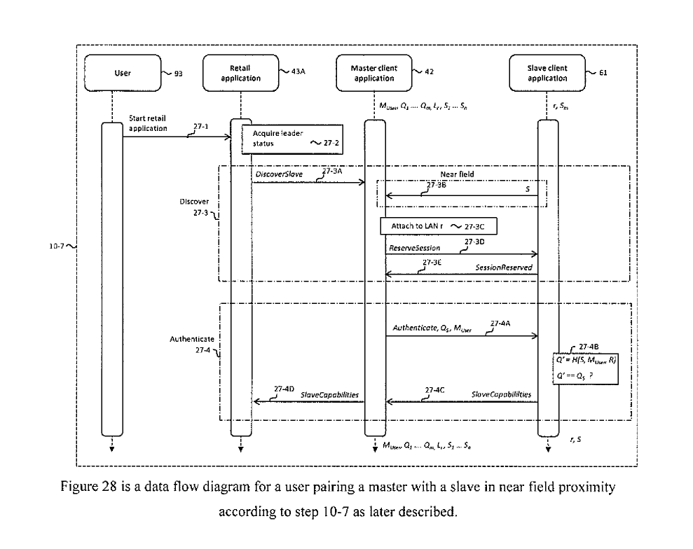

If master client 42 is present, retail application 43A commences discovery of a slave according to step 27-3 and its sub-steps to be described. The data flow diagram of FIG. 28 shows the process of step 27-3 in detail for a slave in near field communication with a master and is described as follows. Retail application 43A sends an inter-process command to client 42 to discover slaves in near field (step 27-3A). As described, slaves 13 broadcast their availability every few seconds to near field proximity (step 13-12A) and as a Zeroconf service (step 13-12B). Master 15A listens for host name S (step 27-3B) and resolves slave's network by looking up table 180 for the network identity r corresponding to S, configures wireless LAN transceiver 21, network adaptor 34 and attaches to LAN r (step 27-3C). Master client sends a request to slave via the LAN to reserve a master-slave session (step 27-3D). Slave client 61 receives the request and returns confirmation to master client if it is available (e.g. because a session is not currently reserved with another master) (step 27-3E). Retail application 43A displays a message 268B to cell 268A to indicate that a slave is available (e.g. “Tap to view . . . ”) (step 27-31). User toggles selection of cell 268A, causing message 268B to toggle to invite the user to disable rendering by the slave (e.g. “Tap to switch off . . . ”) (step 27-3J).

A slave may not be detected during near field discovery steps 27-3A to 27-3E but may nevertheless be accessible to the leader 93A (e.g. because of interference or because either master or slave is not fitted with transceiver 56). If a slave was not found in near field, master client looks up slave host names in table 180 against the LAN to which it is currently attached and polls each slave using the Zeroconf service discovery protocol to determine whether it is contactable and reserves them according to the steps 27-3D and 27-3E previously described (step 27-3F). If no slaves were found (step 27-3G), retail application 43A displays a message 268B accordingly (e.g. “TV not present”) and abandons authentication (step 27-14).

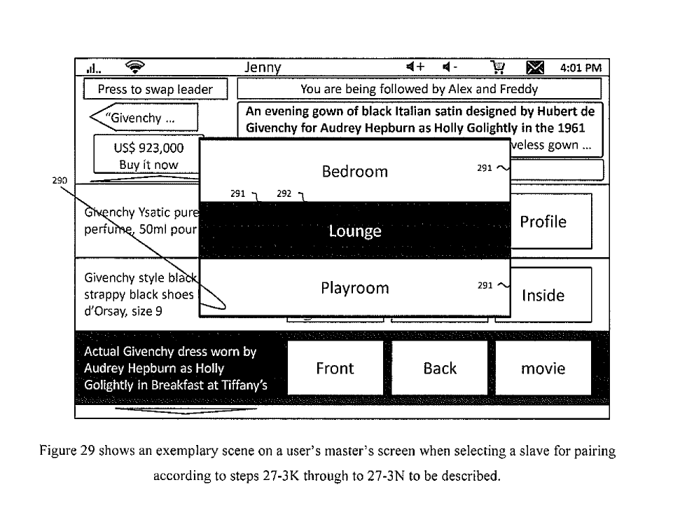

If more than one slave is found, retail application displays a message 268B to cell 268A to indicate that multiple slaves are available (e.g. “Tap to select a TV”) (step 27-3K). User 93A selects cell 268A (step 27-3L) causing retail application to display a pop-up menu 290 inviting leader 93A to select a slave displayed over a scene generated by retail application 43 (27-3M) shown in FIG. 29. A cell 291 is displayed for each slave found where a cell corresponding to the slave selected by leader 93A during a previous execution of this step 27-3M is highlighted differently 292. Leader 93A selects a slave by selecting cell 291 (step 27-3N) and authentication step 27-4 follows.

### Slave Authenticates Master

Leader's master 15A verifies itself to slave during authentication step 27-4, which is described as follows. Master looks up within certificate table 180 for certificates, Q_{S}, with slave's host name S and transmits these with a command to request authentication with its host identity M_{User} (step 27-4A). Slave client 61 receives Q_{S} and attempts to replicate the certificate by calculating Q′=H(S, M_{User}, R) and comparing to Q_{S} (step 27-4B). If Q′ and Q_{S} are identical then Q_{S} is accepted as genuine) then slave sends a service confirmation message to retail application 43A containing capabilities and statuses of slave 13 and those of its connected components (e.g. type and resolution of display 70 and glasses 94) via master (steps 27-4C and 27-4D), and permits user session steps 10-8 and 10-9 to follow.

Step 10-7 (described in sub-steps 27-1 through to 27-4 of FIG. 27) may be employed to authenticate and pair to a slave other applications on master besides retail application 43A, such as remote control application 47 as described in step 10-8A.

### Operation of Retail Application: Step 10-8

Returning to FIG. 26, leader 93A taps a cell 266 to cause the paired slave to save its operating state (e.g. viewing of a particular broadcast channel, playing of an on-demand service, viewing of a programme guide or playing a game) and display the content featured in selected cell 266 according to step 10-9 to be described. Leader 93A may scroll area 261 to reveal other bands 262 by swiping area 261 by touch upwards or downwards. Cell 269B contains descriptive notes for the band or cell highlighted 268. An icon 269C is displayed adjacent to or within each product band 262 conditionally upon a master-slave session (step 10-9) being available when a cell 266 is selected. Some product item bands may not be populated with links appropriate for display on a slave (e.g. because they have too low pixel resolution) or because the paired slave does not have sufficient capability (e.g. to play a cell featuring a video). Alternatively icons 269C may be displayed adjacent to or overlaid upon or adjacent to each of individual cells 266 to denote that they are individually operable according to process 10-9, or cells 266 may be rendered or highlighted differently compared to other cells to denote that they can be displayed to slave (e.g. displayed in a particular colour or border). Cell 269A displays transaction or purchase information, such as price or terms of business for the band highlighted 262A.

### Conditional Display of Cells According to Paired Slave's Capabilities

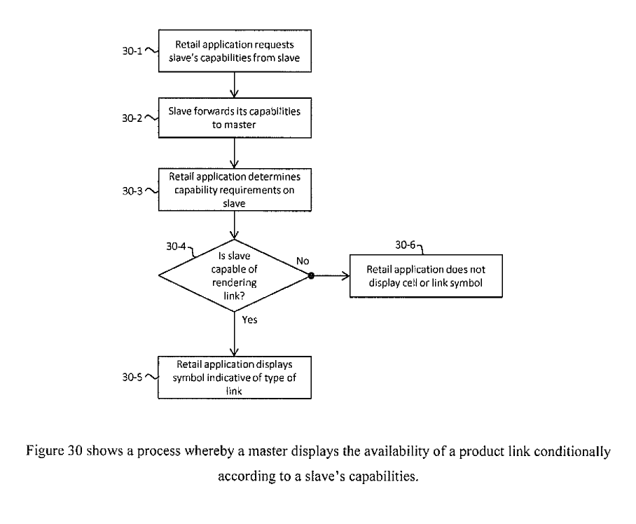

To avoid selection by leader 93A of cells 266 that cannot be displayed by slave, retail application 43A displays each cell 266 conditionally according to the capability of slave 13 to render to display 70 the format referenced by the cell's corresponding URL 253 and downstream URLs 257. For example, a cell 266 denoting a product for viewing stereoscopically is displayed only if slave 13 and display 70 are adapted for rendering of three dimensional images (e.g. the slave's HTML5 browser has WebGL support), if display 70 is adapted for stereoscopic display and if compatible stereoscopic glasses 94 are in operation. The method for conditional display of cells 266 is shown in FIG. 30 and described as follows. As previously described in step 27-4D, retail application 43A acquires the capabilities and statuses of slave 13 and those of its connected components (e.g. display 70 and glasses 94) (step 30-1). Slave 13 forwards these capabilities to master a REST server 69 response (or as an XML file where each capability is a tag construct comprising a parameter name and value) (step 30-2). Tags may include slave browser's 60 user agent string identifier. Master client 42A parses the capability identifiers 252B to discover the requirements of URL 253 on slave browser 60 (step 30-3). If slave is compatible with the requirements of URL 253 (step 30-4) then retail application 43A displays a cell 266 and a symbol 267C indicative of the type of scene (e.g. “3D” logo for stereoscopic scenes, movie camera graphic for video scenes) featured by cell 266 (step 30-5), otherwise a cell and symbol are not shown (step 30-6). Thus a cell 266 is displayed to master contingent upon the capability of slave to render or display the product information related to it.

Remote Control Application and Interaction with Slave: Step 10-8A

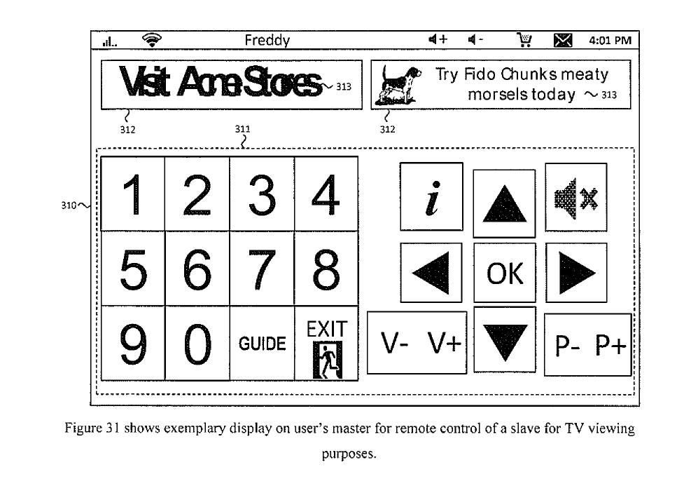

FIG. 31 shows an exemplary display 310 on master 14 screen 22 generated by a remote control application 47. Display 310 comprises an area 311 comprising a plurality of keys each corresponding to a remote control command for the slave (e.g. mute, OK/select, number and arrow keys, volume up/down etc.) where remote control application 47 forwards a command to slave 13 corresponding to the key 311 pressed.

Display 310 may comprise one or a plurality of advertisement panels 312 with a still or animated graphic, text or video 313. The data describing each advertisement 312 comprises a metadata XML file containing control parameters that determine how the advertisement interacts with user 93, as follows:

| Parameter name | Description |
|---|---|
| MetaTags | Key words descriptive of the |
| | advertisement. |
| ActiveUseTime | The period of active use of the remote |
| | control for which the advertisement is to |
| | be displayed. |
| TargetAppID | The identity of the preferred retail |
| | application 43 to be started. |
| ProductCategoryID | The location at which retail application |
| | 43 should open to the user. |
| CellID | The cell 266 to be placed in focus 268 |
| | by retail application 43. |
| SlaveActivityFlag | Determines whether retail application |
| | 43 causes slave to render cell URL |
| | immediately upon starting. |
| DefaultURL | A default URL to be followed if |
| | TargetAppID is not installed on master. |

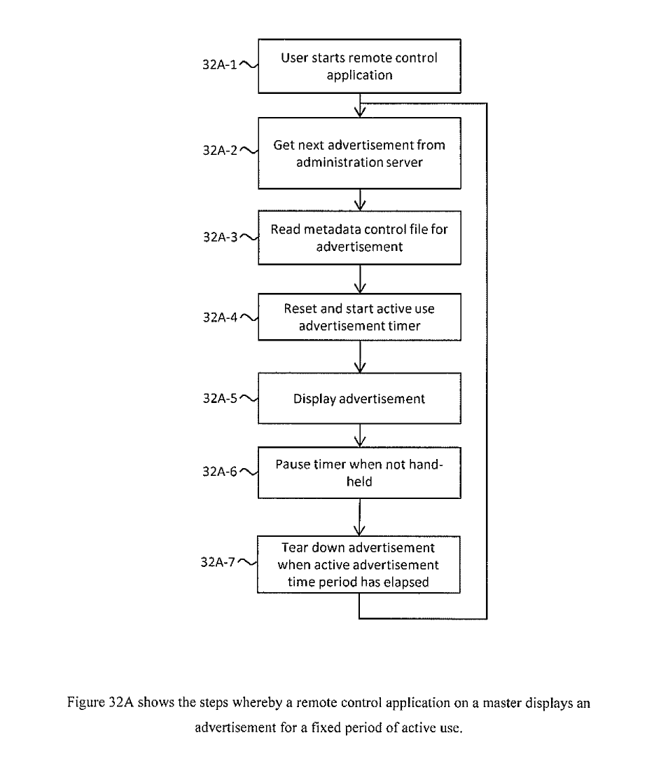

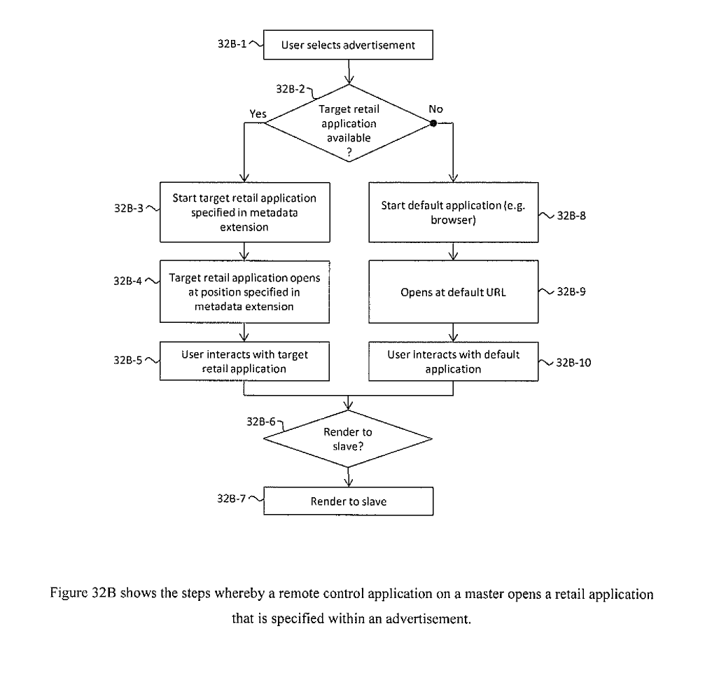

FIG. 32A shows steps in the placement of an advertisement by remote application 47 to achieve a level of awareness of an advertisement that is independent of the level of usage of the remote control, and is described as follows. User starts remote control application (step 32A-1), fetches a data object for advertisement 312 from the administration server 17 (step 32A-2) and parses the advertisement's metadata XML file to recover its control parameters (step 32A-3).

To improve the relevance of an advertisement to the user, remote control application 47 may load viewing metadata, if available, that describes a programme or event viewed by the user on slave device 13 to determine a match or near match between the advertisement metadata and the viewing metadata data. If no match is determined, remote control application 47 rejects the advertisement by deleting the fetched metadata and fetches a next advertisement by resuming the loop at step 32A-2. For example, if the advertisement is accompanied by the meta-tag “football” and the viewing event description, such as is commonly contained in the broadcast DVB event information table (EIT) received by a slave device such as a television, contains the same word “Football” or an equivalent word (e.g. “soccer”) then the advertisement is accepted.

Remote control application 47 initialises to zero and starts a software clock timer 30 built-into master 15 (step 32A-4) and displays the advertisement 312 (step 32A-5). Remote control application 47 pauses the timer by detecting when master 15 is not in active use (i.e. because user has ceased touching keys 311 and master 15 is no longer hand-held e.g. user has placed master down on a firm surface) by sensing when the average intensity across a time series of readings from one or a plurality of master's motion sensors 39 (e.g. 3-axis linear accelerometers) taken over a short period (e.g. 5 seconds) is below a threshold value (step 32A-6). Remote control application 47 tears down display of the advertisement 313 associated with the fetched advertisement data object when timer reaches ActiveUseTime (step 32A-7) and repeats process steps 32A-2 through to 32A-7 for the next advertisement.

### One Touch Click Through to TV

FIG. 32B shows the steps to solve a problem of allowing a user to respond to an advertisement more conveniently via a specific retail application 43 if it is present, allowing the advertised product to be displayed through a retail application on a slave with one key press of advertisement cell 312 and is described as follows. User 93 selects an advertisement 312 (step 32B-1). Remote control application 47 scans master's file system to determine whether retail application 43 with identity TargetAppID is installed and available for use (step 32B-2). If available TargetAppID is started with calling parameters ProductCategoryID, CellID and SlaveActivityFlag (step 32B-3). Retail application starts up and opens to display area 264 and scene 261 corresponding to ProductCategoryID, and places cell 266 corresponding to CellID in focus (step 32B-4). If SlaveActivityFlag is true, then the link 253 associated with CellID is resolved and rendered to slave 13 as later described in step 10-9 or 10-9A where step 35A-1 is performed implicitly by retail application 43A as opposed to by user 93 (steps 32B-6 and 32B-7). Alternatively, if the preferred retail application TargetAppID is not available on master, a predefined alternative default application (e.g. browser 44) is selected according to steps 32B-8 through to 32B-10. Thus, depending on how SlaveActivityFlag is set, user selection of an advertisement may cause either master 15 or both master 15 and slave 13 to display a featured product item or category by a single touch of an advertisement panel 312.

### Eliminating Lock Out, User Distraction and Reducing Power Consumption

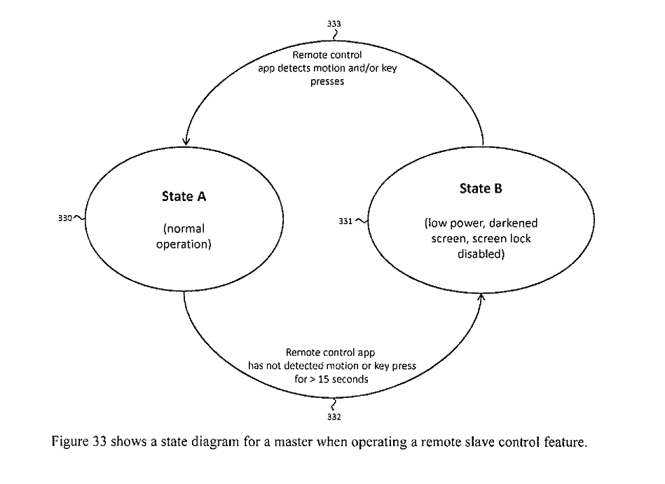

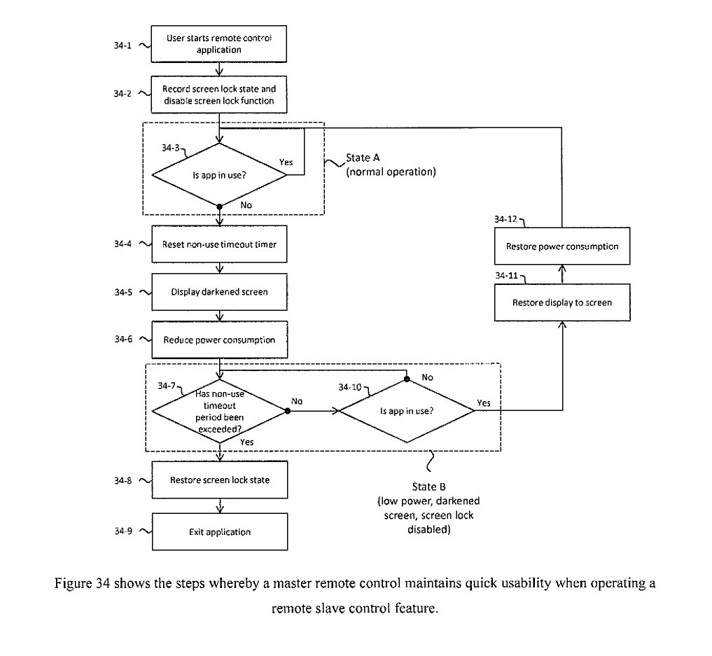

Remote control application 47 (and the remote slave control functionality of retail application 43A and master client application 42 that remain to be described) are adapted to overcome usability problems as described. Some users are deterred from use of soft remote control applications because they must repetitively perform relatively complex tasks, such as pressing a complex sequence of keys to log onto the master and navigate through its user interface in order to press just one or a small number of remote control keys (e.g. mute). Others concerns include the relative high energy consumption and consequent drain on battery of a master with soft remote application compared to a normal RCU because the master's CPU, display and other components require more power and remain active for long after the remote control keys themselves are pressed. Inconvenience to user 93 from light emitted from master 22 while viewing TVs in darkened rooms (i.e. before the PND returns to low power standby) is another problem. FIG. 33 shows a solution to the foregoing problems where remote control application 47 causes master 15 to switch between a powered up, normal state of operation (A) 330 and a low power, darkened state (B) 331 where the power is reduced and screen lock out is disabled. A period without motion (e.g. due to the master being placed on a firm surface) coincides necessarily with user inactivity with a remote control device and triggers a transition 332 from state A to B. Conversely, detection of motion due to being picked up or hand-held triggers a transition 333 from state B to A. FIG. 34 shows the steps in more detail and is described as follows. User 93 starts the remote control application 47 (step 34-1) which records whether screen lock function (e.g. where user is logged out automatically from the master if a timeout period of non-key presses has elapsed) is set and, if it is set, disables it (step 34-2). Remote control application 47 follows a repeating loop to detect motion and/or key presses to keys 20 or screen 22 that indicate that it is in use (step 34-3). If no motion below a threshold level and no key presses are detected for a minimum user configurable period (typically 15 seconds), remote control application 47 prepares to enter a suspended state (B) by initialising to zero and starting a timer to measure the time since last use of remote control application 47 by user (step 34-4), darkening screen 22 (e.g. by reducing power to the display) (step 34-5) and reducing power consumption from unnecessary components in master (e.g. by reducing CPU clock frequency) (step 34-6). Remote application 47 enters state B characterised by following a repeating loop to verify that a user configurable timeout period (the longest period likely to elapse between use of a remote control during TV viewing, typically 30 minutes to an hour) has not elapsed (step 34-7). Remote application 47 restores the screen lock functionality recorded during step 34-2 (step 34-8) and terminates (step 34-9) if the timeout period has elapsed. Otherwise remote application 47 detects intention to use the remote control by detecting motion from sensors 39 over a minimum threshold value (step 34-10) before restoring display illumination (step 34-11) and normal powered operation (step 34-12).

### User Control of Slave: Step 10-9

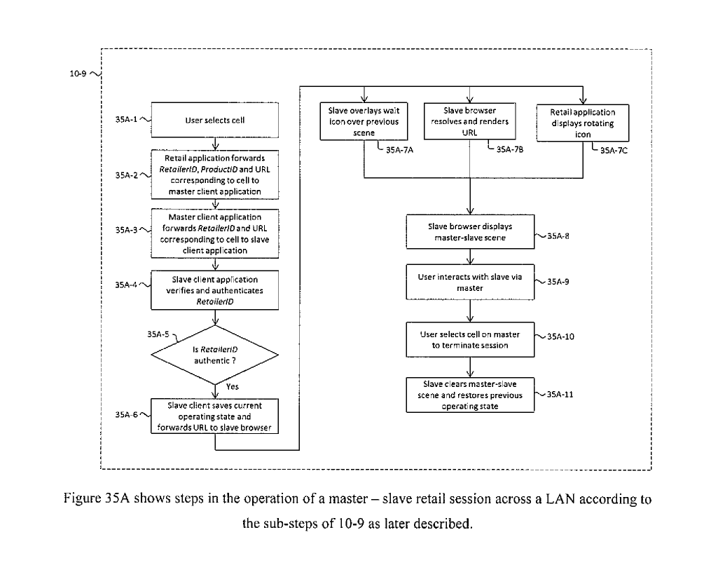

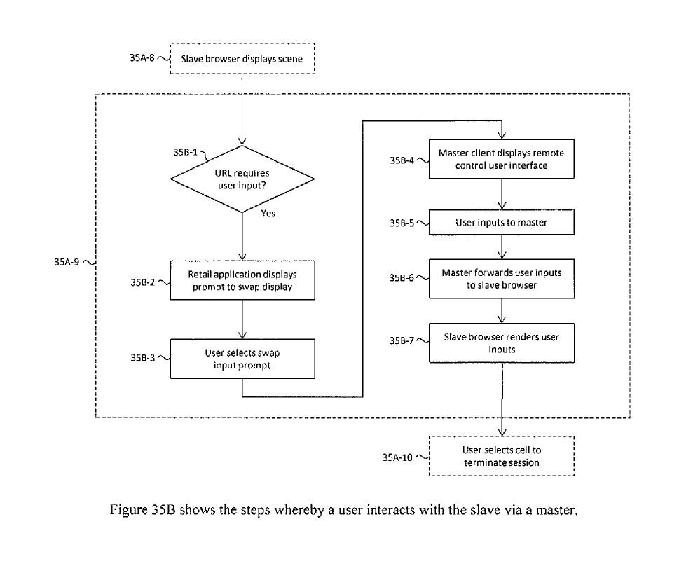

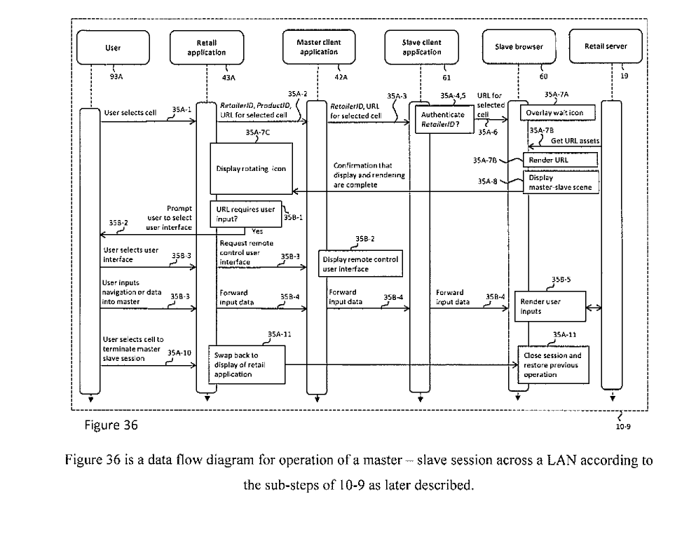

The process for a leader 93A to cause a product to be displayed on his/her slave device that corresponds to cell on his/her master 15A is described as follows, where FIG. 35A and FIG. 35B show the sub-steps of the master-slave control session and FIG. 36 shows the data flows between the entities. User selects cell 266 (step 35A-1) and retail application 43A forwards its identifier RetailerID, an identifier for the product item referenced by cell 266 ProductID and the URL 253 that corresponds to the selected cell 266 to the master client application 42A (step 35A-2). Master client application 42A highlights icon 269C associated with selected cell 266 (e.g. as flashing or rotating) during steps 35A-2 through to 35A-8 to notify user that the cell has been selected and is being rendered or played by the slave until a confirmation status is received from slave browser 60 that rendering or playing is complete. In the preferred embodiment described, URL 253 references content that is hosted by and served from retail server 19 or elsewhere in the Internet. However, in alternative embodiments, URL 253 may reference content that is stored on master 15A and hosted by a local server application (e.g. Mongoose or Apache) in layer 41.

Alternatively URL 253 may reference content served from the Internet via a proxy server application located in layer 41 master 15A. Master client application forwards RetailerID and URL to slave client application 61 (step 35A-3). Slave client application looks up RetailerID to verify that it is present in the approved list of retailers RetailerList uploaded during earlier step 13-10B (step 35A-4). Other embodiments of the invention may take additional steps to verify that retail application 43A issuing the URL 253 is bona fide by authenticating RetailerID as a certificate. Slave client application 61 saves its operating state (e.g. currently viewed broadcast channel, position within a user interface such as a programme guide) and forwards the URL to slave browser 60 if retail application 43A is authentic (steps 35A-5).

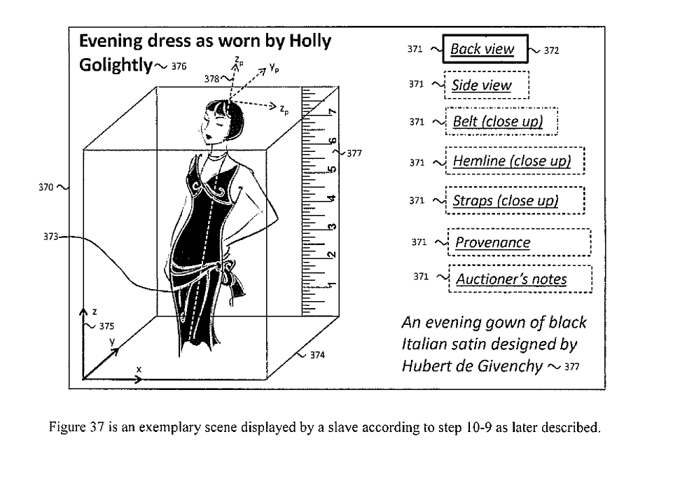

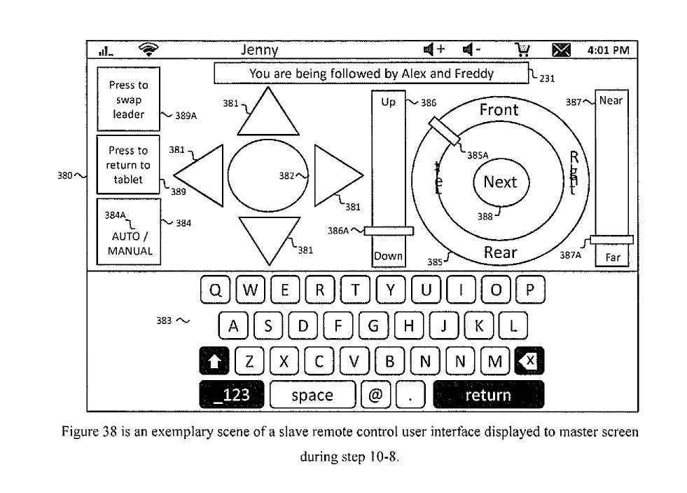

Slave browser 60 resolves and renders or plays the resources referenced by URL 253 to display 70 according to their type (step 35A-7B), e.g. an HTML web page or scene or a still image or a video clip, shown in scene 370 of FIG. 37. Scene 370 is described by data 254 (referring to FIG. 25) that may contain one or more URLs 257 to another scene 258 that may be rendered by slave (displayed as links 371 in FIG. 37) or an input tag 256 corresponding to a visual field where user can input characters (e.g. to key in a name or a password). Retail application 43A determines whether URL 253 points directly or indirectly to input 256 tags either by reading a pre-processed metadata tag 252A for URL 253 within cell data 252 or by following link 253 and all downstream URLs (e.g. 257 in FIG. 25) recursively to determine whether user input is needed to master 15A (step 35B-1). If input is required retail application 43A updates cell 268A (referring to FIG. 26) with a message 268B prompting user to swap master scene for remote control of slave (e.g. “Tap for remote control”), step 35B-2. User selects cell 268A by tapping it (step 35B-3) to cause retail application 43A to request master client 42A to display a remote control user interface scene 380 (step 35B-4) to its screen 22 shown in exemplary FIG. 38. In alternative embodiments retail application may swap scene automatically from 260 to 380 without prompting user. Master client forwards data corresponding to user inputs to arrow cells 381 and OK cell 382 to slave browser (step 35B-4). User may input text data via soft keyboard 383.

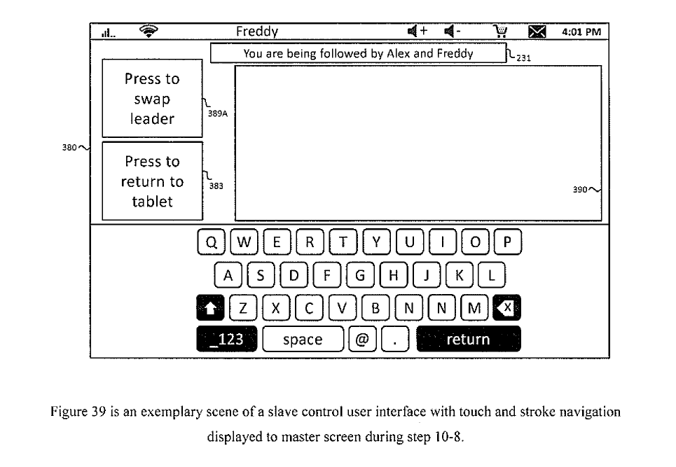

FIG. 39 shows an alternative arrangement of master control scene 380 where touch sensitive key cells 381 and 382 are replaced by touch panel 390 and arrow movement is interpreted by master client application framework 45 from finger swipes and taps across panel 390. Any combination of touch, swiping, tapping and input via physical keys is possible.

Slave browser renders link referenced by cell 266 to screen 70 as shown in exemplary scene 370 of FIG. 37, marks links 371 (if any) and highlights one link as in focus 372.

Scene 370 depicts one or a plurality of products 373 (e.g. such as the dress shown in FIG. 37) for viewing (e.g. as a photographic still image such as PNG or JPEG, or a motion video image such as MPEG-4 parts 11 or 16, or set of three dimensional polygons rendered as three dimensional object via WebGL). Viewing may be stereoscopic where the apparent orientation of product 373 may be altered by leader 93A (see later). Product 373 is displayed initially in a default orientation, distance, height and azimuth as apparent to the viewer (e.g. front facing user and partially filling frame of display 70). Product 373 may be annotated with labels 376 and/or descriptions 377. A multi-dimensional framework 374 may be displayed alongside or enclosing product 373 to give viewers 93 a sense of product 373 orientation. Framework 374 may be marked with axes and labels 375. Axes of orientation of the product 378 may be displayed adjacent to product 373 or overlaid upon framework axes and labels 375 to give viewers a sense of orientation. A calibrated ruler or other graphical size reference 377 may be displayed alongside product 373 or framework 375 to allow viewers to obtain a sense of absolute product scale.

### Graphical User Interface Manipulation of Product in 3D

Product 373 may be represented visually as a still image or a video clip. Product 373 may comprise a representation of a three dimensional object (such as may be described using WebGL) that may be rotated to an orientation controlled by leader's master device 15A. Product visual 373 may be rendered to display 70 in stereoscopic format for viewing by user 93A using stereoscopic glasses 94 if required.

User manipulates arrow keys 381 to move focus 372, presses OK 382 to select link 372 and QWERTY touch keyboard 383 to input key data to slave browser into fields where required (step 35B-5) via master client 42A (step 35B-6) and slave browser 60 renders accordingly (step 35B-7).

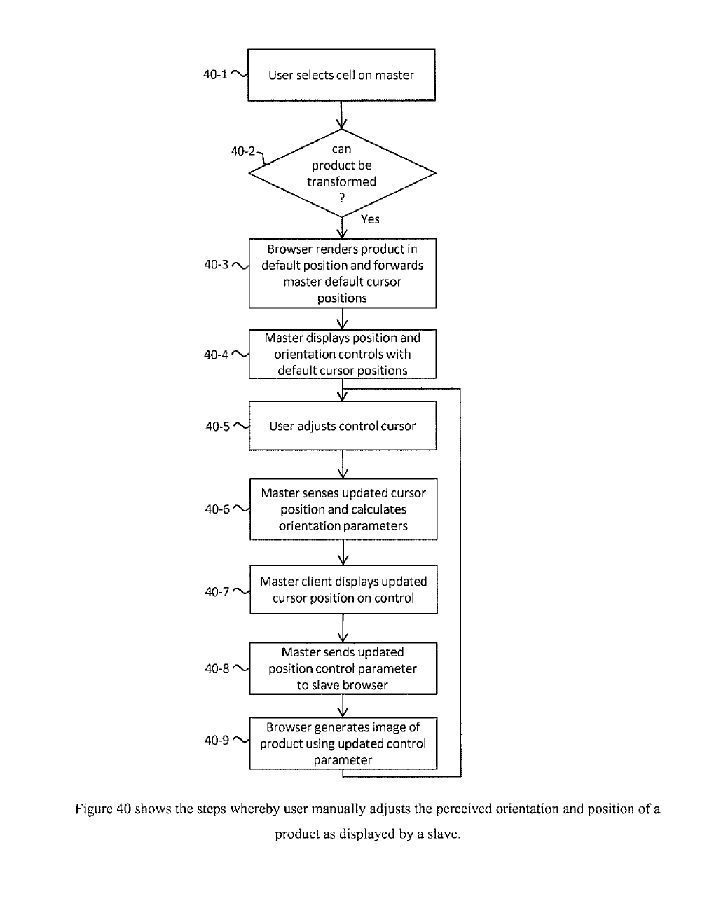

FIG. 40 shows the process whereby the apparent position and orientation of product 373 to user is controlled and updated. To avoid clutter to screen 22, additional touch sensitive controls 385, 386 and 387 are displayed to remote control scene 380 conditionally upon slave 13 being able to adjust the orientation and position of product 373 perceived by user 93 (e.g. because product 373 is rendered as a WebGL object). First, user selects a cell 266 for display of a product on the slave as previously described for step 35A-1 (step 40-1). Master client 42A inspects the embedded metadata requirements 252B to determine whether the perception of product 373 featured by URL 253 may be transformed by the user (e.g. by rotation) (step 40-2). If product 373 can be transformed, slave browser 60 forwards to the master client parameters describing the default product orientation together with minimum and maximum user selectable values and control scale type (e.g. linear, square, logarithmic) for each user control 385, 386 and 387 (step 40-3). Master client displays the user controls to master 15A screen 22 and displays their respective cursors 385A, 386A and 387A in positions on their respective controls according to the default product orientation as received from slave browser during previous step 40-3 (step 40-4). Circle 385 controls the angle of orientation of product 373 in the horizontal x-y plane according to the angular position on its circumference of where it was last touched by user (e.g. touching circumference of circle 385 at the 0 degree position requires slave browser to render product 373 with its front facing out of the screen 60 at user, whereas touching at 270 degree position causes left profile of product 373 to be displayed). Control 386 is an “elevation” slider bar that adjusts the perceived angle of elevation of user with respect to the x-y plane. Control 387 is a “zoom” slider bar that adjusts a user's apparent distance to product 373. For example, if master 15A received 0.5 m, 0.75 m, 1.0 m and “linear” as the minimum, default, maximum and scale type for perceived distance to the product during step 40-3, then cursor 387A would be placed at the midpoint position on distance control 387 in step 40-34. User may touch a cursor 385A, 386A or 387A and slide cursor to the desired position or orientation of product 373 (step 40-5). When a cursor is moved, master client calculates and sends updated position and orientation coordinates of user with respect to product to slave browser 60 to permit display 70 to be displayed (step 40-6). Master client updates the displayed position of the relevant cursor 385A, 386A or 387A (step 40-7) and sends the updated position or orientation parameters to slave browser (step 40-8). Finally, slave browser recalculates the polygon positions of product 373 using the updated position or orientation parameter and renders to display 70 (step 40-9). The process repeats through steps 40-5 to 40-9 as user makes further adjustments to his/her position with respect to product 373 and to its orientation. Display 380 may carry graphical user controls and cursors to allow product 373 to be rotated in additional planes to the x-y plane and manipulated in other ways such as to change its appearance such as with a key 388 that user may press to cause retail application to be toggled through display of the product 373 according to a sequence of product options (e.g. colour, pattern). For example, product 373 may be available in three colours: red (default), green and blue. Pressing key 388 successively would cause browser to render product 373 next as green, then blue, cycling back to red.

### Intuitive Manipulation of Object by Rotating Master

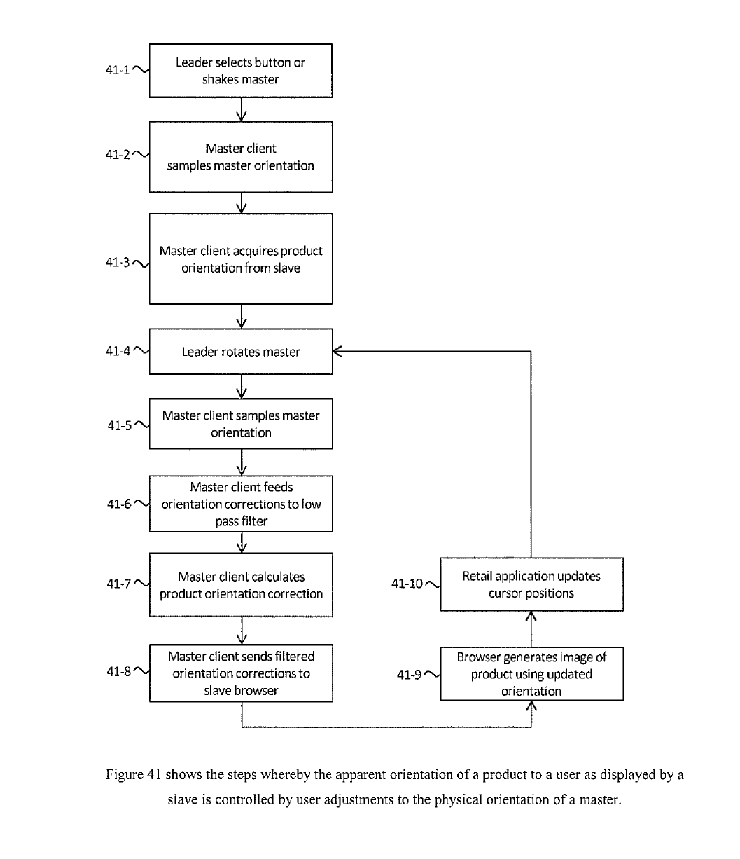

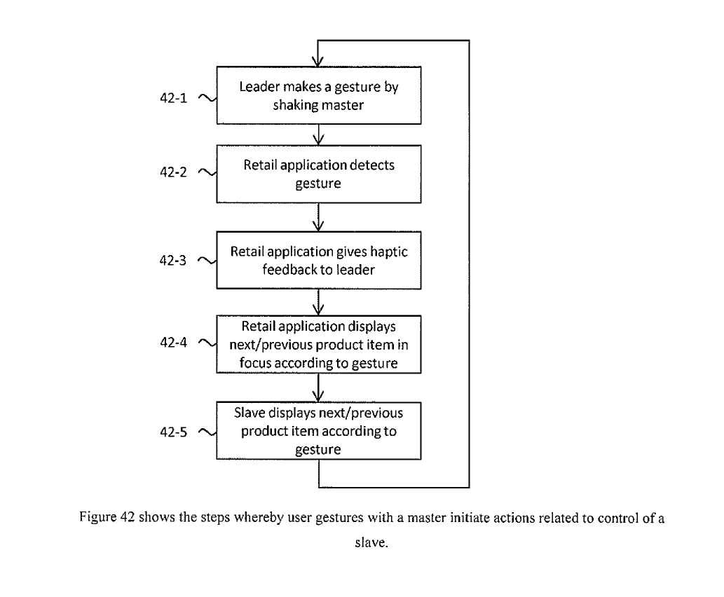

Many users experience hand-eye coordination difficulties when manipulating objects viewed on a distant screen using a local graphical interface. Problems are increased when the objects requiring manipulation are displayed in three dimensions and users are required to swap their field of vision repetitively between distant objects and local devices. It is consequently desired that users should be able to view and manipulate the perceived orientation of a distantly viewed (such as from a sofa to a TV) product 373 in a more intuitive manner where they are not required to view also a graphical user interface. A means is described whereby users may alter the perceived orientations of products 373 in the same way they would manipulate physical objects with their hands so that, as leader 93A rotate masters 15A using his/her hands, products 373 are displayed, animated in real time according to orientation updates repetitively received by slaves 13 from master 15A across LAN 10. FIG. 41 shows steps whereby leader 93A may cause perceived orientation of product 373 to update automatically and animate according to the physical orientation of master 15A and is described as follows. By default key 384 is marked with a label 384A reading “MANUAL” to indicate that automatic product orientation by hand (according to the steps to be described) is not in operation. Leader toggles key 384 to activate an automatic rotation function (step 41-1). So as to overcome a problem of user having to look at key 384 in order to engage it, leader may alternatively shake master 15A whereby master client 42A is operable to read linear accelerometer sensors 39 to detect and interpret a tap or shaking motion as a control signal from leader to activate the automatic rotation function. Toggling key 384 or shaking master causes master client to display the auto-rotate label 384A as “AUTO” to indicate that automatic product orientation is in operation. Master client measures master's three dimensional Euler vector axis and angular orientation, m_{base}, by sampling master's 15A embedded orientation sensors 39 (e.g. Hall effect and/or MEMS gyroscopic) at a time immediately prior to when key 384 is pressed or when master device is shaken or tapped (“base time”) (step 41-2). Master client polls slave browser 60 to detect product Euler vector axis and angular orientation 378, P_{base}, at the base time (step 41-3). Leader physically rotates master 15A with his/her hands (step 41-4). Periodically, typically every 20 to 100 milliseconds, master client 42A reads orientation sensors 39 to compile a time series of samples of master 15A orientation, M={m₀, m₁, . . . mᵣ} (step 41-5). Master client transforms M to compile a filtered time series M′={m′₀, m′₁ . . . m′ₛ} by applying a digital low pass filter algorithm to M to eliminate jerkiness induced by sampling noise and/or involuntary user movement (step 41-6). Master periodically (e.g. every 100 milliseconds) transmits the corrected end point of the filtered series, m′ₙ−m_{base}+p_{base}, to the slave browser (steps 41-7 and 41-8). Slave browser performs a three dimensional rotation of the object corresponding to product image 373 to orientation m′ₙ−m_{base}+p_{base} and renders to display 70 (step 41-9). Finally retail application 43A updates positions of cursors 385A, 386A and 387A so that they visibly track the product 373 orientation in real time as leader adjusts master 15A orientation (step 41-10). Steps 41-4 through to 41-10 are repeated (typically at a frequency of 10 to 50 times per second) until user toggles auto-rotation key 384 to its off state, or user shakes or taps master, causing auto-rotate indicator 384A to read “MANUAL”. Alternative embodiments of the system of the invention may perform the low pass filtration (step 41-6) and orientation correction (step 41-7) steps, or a part thereof, in slave device 13.

User presses cell 389 to terminate input (step 35A-10) causing retail application 43 to swap display on screen 22 from scene 380 to scene 260, and to signal to slave 13 to tear down display of URL 253 from display 70, terminate the interactive session and restore its operating and display state previous to step 35A-1 (e.g. the TV channel the slave was tuned to previously) (step 35A-11).

Switching Slave Display from Product to Product Using Gestures

Operator of retailer server 19 may group and arrange for the spatial order of cells 266, rows 262 and scenes 261 to follow a particular sequence so as to show different variants (e.g. colours, patterns or styles) of the product 373, so that leader 93A may advance viewing on slave from cell 266 to adjacent cell 266 according to the same sequence. For example, in the case of the highlighted product item 268 of FIG. 26, the viewing sequence on the slave as described by the cells 266 would be the “front” view, then the “back” view and then to end with a movie. It would be desirable for leader 93A to be able to advance viewing from one cell to the next by making motion gestures such as by waving master 15A to switch display on the slave from one cell 266 to the next without looking at or touching screen 22. FIG. 42 shows the steps and is described as follows.

| Gesture | Description of action |
|---|---|
| Master 15A shaken | Advance focus 268 to next cell 266 (from top |
| vertically by | left to bottom right, advancing down a product |
| leader 93A for | row 262 when required, scrolling scene 261 to |
| greater than | the next page down when required) and select |
| 1 second. | cell for rendering and display on slave. |
| Master 15A shaken | Retreat focus 268 back to previous cell 266 |
| horizontally (e.g. | (from bottom right to top left, retreating up a |
| between leader | product row 262 when required, scrolling scene |
| 93A's left and | 261 up to previous page 261 when required) and |
| right directions) | select cell for rendering and display on slave. |
| for greater than | |
| 1 second. | |

For the gestures described it is necessary for the master to determine the vertical (gravitational) axis prior to step 42-1 by obtaining an average 3-axis linear accelerometer reading over several seconds. Leader holds and shakes master 15A to make one of the two gestures in the table above (step 42-1). Retail application 43A detects when a gesture is made and differentiates between the two gestures using time series sampling from accelerometer and magnetometer sensors 39 and digital motion processing methods (step 42-2). The vertical shake gesture is detected when the average of the dot product of the average acceleration vector and gravitational vector over a running sampling period of a second exceeds a threshold value. Conversely the horizontal gesture is detected when the average of the magnitude of the cross product of the acceleration vector and gravitational vector over a running sampling period of a second exceeds a threshold value. A significant delay of a few seconds can occur between when a user makes a gesture according step 42-1 and when the requested scene is displayed to the shopper. As a result retail application gives haptic feedback to the user using transducer 35A by making a vibration or sounding a buzzer in order to confirm to leader 93A that his/her gesture is accepted (step 42-3). Additional feedback may be offered to user, such as two vibrations closely spaced together in time to warn the leader that an error has occurred, e.g. loss of LAN or Internet connection, and to prompt user to look at scene 260 on master for more information. Moreover retail application may offer feedback of same information in different forms such as via an audible message (e.g. a bleep or synthesised vocal response). According to the nature of the gesture (e.g. forward or back) retail application advances or retreats focus to the next cell 266 in the sequence displayed on scene 261 (step 42-4). Retail application causes the product item associated with the new cell in focus to be displayed by the slave according to steps 10-9 previously described (step 42-5).

### Transfer of Leader Status Between Shoppers

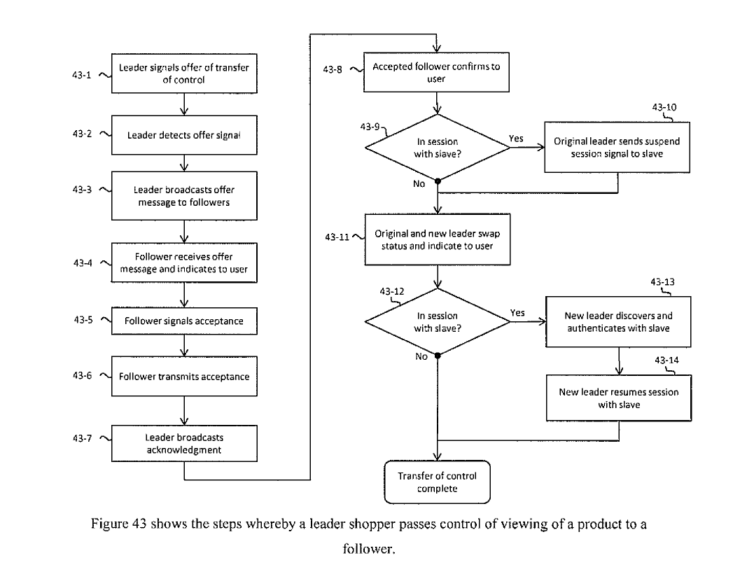

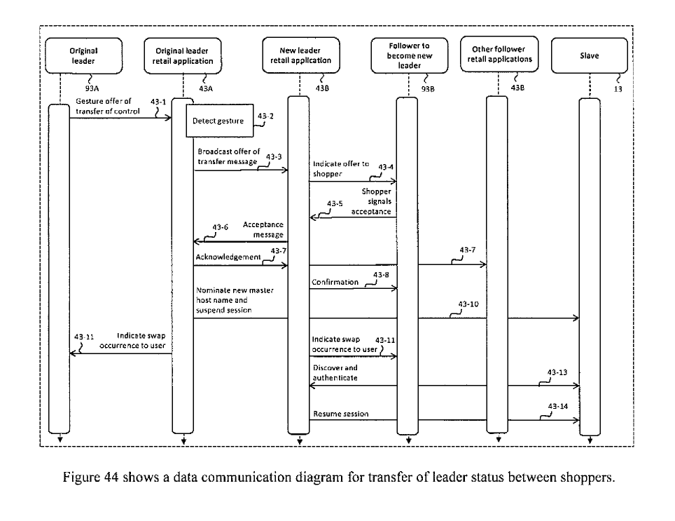

FIG. 43 shows the steps whereby shoppers can examine and comment upon a product together, preferably while watching the product on a TV without looking at the screens on their master devices, by exchanging control of the product between shoppers, and is described as follows. Leader 93A touches a control key 389A on his/her master screen 22, or alternatively taps or impacts master 15A against a hard surface, to signal an offer of transfer of control to a follower 93B (step 43-1). The leader retailer application 43A broadcasts the offer event across LAN 10 to the follower retailer applications 43B (step 43-3). New leader retail application signals the offer to its user by highlighting (e.g. by illuminating or animating) swap key cell 389A on followers' master screens or by giving a haptic signal to follower such as previously described for step 42-3 (step 43-4). One or more followers may accept the offer by pressing swap key 389A or making a shake or tap gesture (step 43-5). The acceptance is detected by follower retailer application and transmitted as a message back to the leader retail application (step 43-6). An acknowledgement of the first acceptance received by the original leader retail application is broadcast by the leader retail application to all follower retail applications including the retail application that accepted (step 43-7). The accepted retail application (to become the new leader retail application) gives a confirmation to its user, preferably by haptic (e.g. by causing the master device to vibrate) or by audio (e.g. a buzzer or bleep) feedback (step 43-8). If the original leader retail application is in session with a slave (step 43-9) it nominates the host name of the new leader application's master to the slave and sends a suspend message to slave 13 causing it to wait for a timeout periods of a few seconds while the new leader retail application attempts to discover the slave and authenticate itself as previously described for step 10-7 (step 43-10) where, if the timeout period is exceeded, slave tears down display and resumes its previous operation (e.g. playing a TV program). The original and new leader retail applications and their follower retails applications update their status displays 231 (step 43-11).

An alternative approach to steps 43-1 through to 43-8, which does not require a separate acknowledgment gesture from the follower, may be employed where shoppers bump their master devices together according to steps 24-1 to 24-23 previously described.

### Metering of Shopping Events

A “shopping event” is the occurrence of one or a combination of the following shopping functions:
1. Administration of a slave according to the steps of 10-4 and steps 13-1 through to 13-14 (a “slave administration” shopping event);
2. Administration of a user according to the steps of 10-6 and 14-1 through 14-18 (a “user administration” shopping event);
3. Change to the status of a leader or follower shopper according to the steps of 10-6A, 10-6B and 24-1 through to 24-23 (a “group” shopping event);
4. Completion of a master-slave session according to the steps of 10-9, 35A-1 through to 35A-11, and 35B-1 through to 35B-7 (a “slave” shopping event).

Transaction event types (Transaction Type) include the purchase, maintenance, servicing, obtaining warranty, giving feedback on or returning of a product or service. An objective of the invention is to maintain the same functionality for transactions events within retail applications 43 irrespective of whether shopping events occur. Because transaction events do not report shopping events, a means is required to measure the number of transaction events that occur due to shopping events. It is desired to measure the contributions to transaction events from individual components of the master and slave system (e.g. the number of transaction event that are attributed to a particular a retail application or model of slave device). For example, it is desired to determine how many transaction events have occurred as a result of shopping events where shoppers have engaged in a group to view a particular product and purchased its several minutes later. It is desired to determine how many transactions events occur as a result of a shopper examining a product item on a particular model of slave device and then buying it later from a personal computer or a real shop.

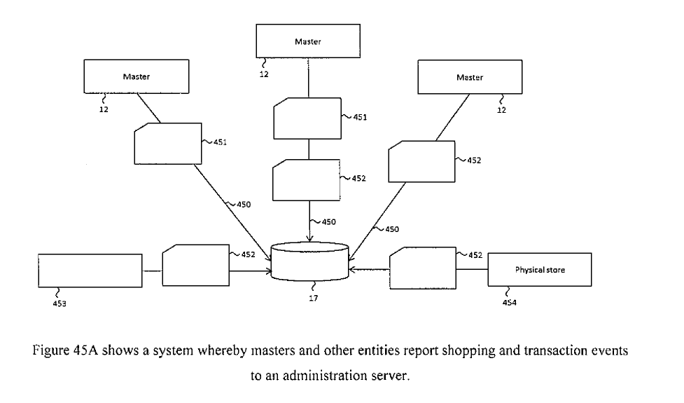

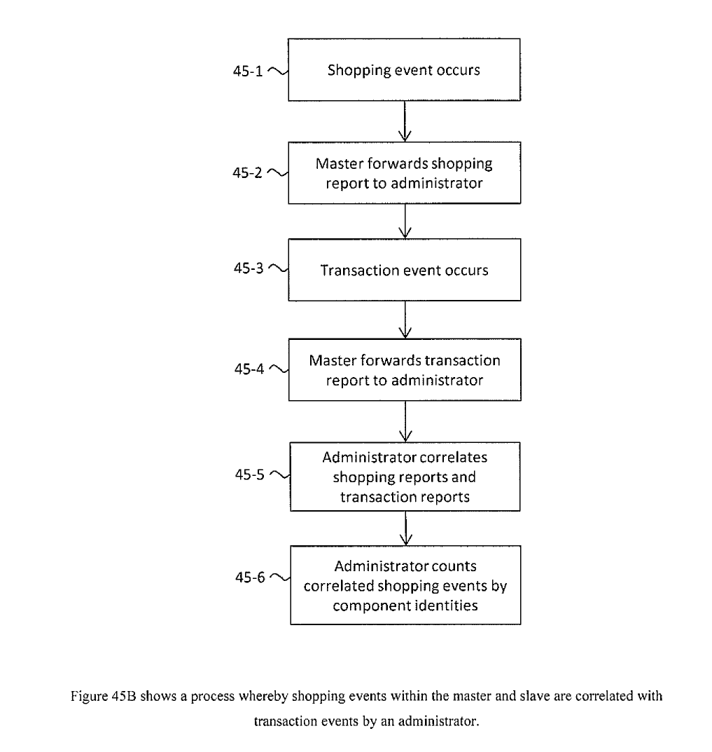

FIG. 45A shows the system of the invention whereby reports of shopping events 451 are transmitted from masters 12 to administration server 17. Each shopping report 451 contains:
1. an identifier of the type of shopping event (ShoppingEventID);
2. the type of shopping event (e.g. “slave administration”, “user administration”, “group” and “slave” described earlier) (ShoppingType);
3. an identifier of the product item (ProductID) involved in the event;
4. an identifier of the retail application (RetailerID) involved in the event;
5. an identifier of the user (UserID) involved in the event;
6. an identifier of the master model and manufacturer (MasterID) involved in the event;
7. an identifier of the slave model and manufacturer (SlaveID) if it is involved in the event;
8. an identifier of the time and date of the shopping event (TimeShopped).

Reports of transaction events 452 are transmitted from masters 12, other devices (such as personal computers) 453 and from in-store purchases 454 to administration server 17.

Each transaction report 452 contains:
1. an identifier of the product item (ProductID) involved in the event;
2. an identifier of the transaction type (TransactionType);
3. an identifier of the retail application (RetailerID) involved in the event;
4. an identifier of the user (UserID) involved in the event;
5. an identifier of the time and date of the transaction (TimeTransacted).

FIG. 45B shows the process of the invention whereby the occurrence of a shopping event is correlated with transaction events. A shopping event occurs according to the steps previously described (step 45-1). Master 12 forwards the shopping report to administration server 17 (step 45-2). Retail application 43 generates a message for report 451 and forwards it to administration server 17 via master client application 42 across the Internet 11. If and when a transaction later occurs (step 45-3), master forwards a transaction report 452 to administration server 17 (step 45-4). Alternatively, transaction report may originate from another device 453 or from a purchase in-store 454. Administration server 17 correlates the shopping reports 451 with the transaction reports 452 (step 45-5) according to whether they contain the common identities ProductID, RetailerID and UserID and the transaction event occurs within a fixed time period Guard Time of the shopping event, i.e.: whether:

TimeShopped<TimeTransacted<TimeShopped+GuardTime

Administration server 17 counts the correlated events according to step 45-5 for a given component to quantify its contribution to the transaction events (step 45-6). For example, to determine the number of transactions where a particular model of slave device was involved, the administration would count the number of correlated records where shopping records contained the desired value of SlaveID.

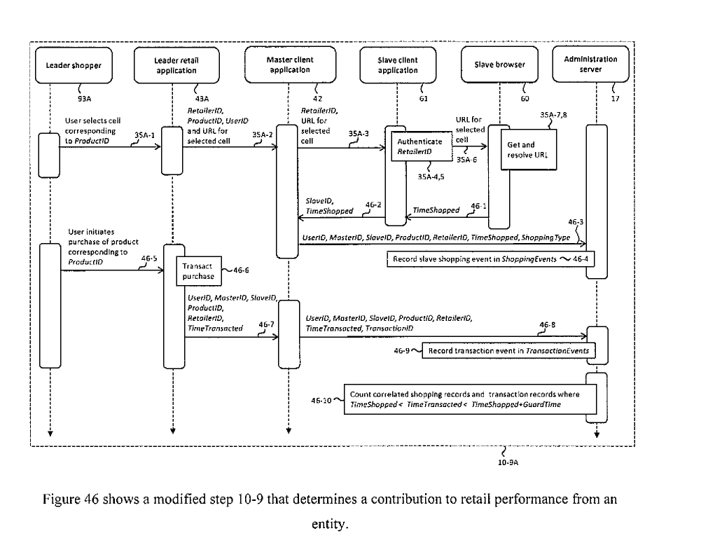

FIG. 46 shows the additional steps to process 10-9 for measuring correlated shopping records and transaction records for the case of slave shopping events and is described as follows. The shopping event (step 45-1) comprises the steps where user 93A selects a cell 266 for display on the slave (step 35A-1 previously described) and retail application 43A forwards the cell's product identifier ProductID, an identifier of the retailer application RetailerID and an identifier of the user UserID to the master client application as part of step 35A-2 previously described, and renders the product item on the slave display 70 (steps 35A-7 and 35A-8).

The master forwards the shopping report to the administrator (step 45-2) by master client application 42 receiving SlaveID, TimeShopped from slave client application 61 after the product item is displayed by the slave (steps 46-1 and 46-2) and forwarding with additional parameters ProductID, RetailerID, UserID, ShoppingType received from retail application 43 to administration server 17 (step 46-3) to form a record of the shopping event and log it to a table of shopping events ShoppingEvent in administration server 17 (step 46-4).

During transaction event of step 45-3 leader shopper 93A initiates a transaction via retail application 43A (step 46-5) which completes the transaction with retail server 19 with identity RetailerID (step 46-6).

The master forwards the shopping report to the administrator (step 45-4) by retail application 43A recording the time and date when the transaction event commenced, TimeTransacted, and logging details of the transaction administration server 17 via master client 42 (steps 46-7 and 46-8) as a transaction record to a table of transactions TransactionEvent (step 46-9).

Administration server 17 correlates the shopping events and transaction events (step 45-5) at a later time by executing a batch process for each accounting time period (e.g. monthly) to count the correlated events by counting for each given UserID and products of given ProductID the number of records within ShoppingEvent whose browse times TimeShopped precede within the period Guard Time the transaction times TimeTransacted of records in TransactionEvent of matching UserID and ProductID for a given RetailerID, MasterID or SlaveID (step 46-10).

It is thus possible to determine from the number of counted records the absolute contribution a particular retailer or manufacturer of master or slave devices makes to the process of the invention (step 45-6). For example, to determine the number of transactions associated with a retailer “Acme Stores”, the record count would be expressed in Structured Query Language (SQL) in the following form:

```
DECLARE @GuardTime INT;
SET @GuardTime = 30;
SELECT COUNT (TransactionEvent.RetailerID) FROM ShoppingEvent
      INNER JOIN TransactionEvent
      ON ShoppingEvent.UserID = TransactionEvent.UserID AND
      ShoppingEvent.ProductID = TransactionEvent.ProductID AND
      ShoppingEvent.RetailerID = TransactionEvent.RetailerID
      WHERE DATEDIFF (MINUTE, ShoppingEvent.TimeShopped,
      TransactionEvent.TimeTransacted) <= @GuardTime
      AND TransactionEvent.RetailerID = ‘Acme Stores’;
```

In the embodiment described, a shopping event is counted even if the transaction occurs from a different master device (e.g. a user's tablet) to the master device (e.g. same user's smart phone) which initiated the slave shopping event during steps 10-9. In alternative embodiments tables ShoppingEvent and TransactionEvent may be held locally within a master device and limited to shopping events initiated within the master. Other embodiments may employ alternative and arbitrary logical functions to correlate the shopping event records and transaction event records, in place of time as described, to deduce whether a correlation has occurred. These may be functions, for example, of other parameters logged to each record such as internet address of LAN 10 or geographic location (as sensed with GPS sensor embedded within masters 12).

Other sub-divisions between the functionalities taught for master client application 42 and retail application 43 are possible. For example all or part of the functionality taught for retail application 43 may instead be contained instead within master client 42 so as to minimise redundant code and functionalities when multiple retail applications 43, each of different identities RetailerID, are installed to the same master device 12.

Masters and slaves may be composed of different architectures, application frameworks and operating systems and be interoperable according to the processes described. Other software architectures for 38 and 58 are possible. For example, various components of architectures 38 and 58 do not have to be separate processes but can be part of a single process performed by operating system, 46 or 64, or a single application.

As described, multiple retail applications 43 may be installed to a master and control slaves via communication interface 46A with a master client application. Retail application 43 may be a browser adapted to parse meta-elements in tags that characterise cells 266 according to the processes described.

In the embodiment described master presents certificates to specified slave to enable the functionality of steps 10-8 and 10-9. Other embodiments may convey certificates to enable different functionalities such as may be performed by other applications (e.g. access to slave's native features such as power on/off, change channel or access to the Internet 11 via browser 60).

As described for the preferred embodiment, role of administration server 17 include the processes of backing up information held on administrator's master 14 and restoring portions back to administrator or other users' masters and slaves according to the process described. Alternative embodiments may incorporate some or all of the functionality of administration server 17 into administrator's master 14 or slave 13. Alternative embodiments may employ different cryptographic algorithms or methods to change or improve the level of security conferred to the system of the invention.

The invention and all of the functional operations described herein can be implemented in digital electronic circuitry, or in computer hardware, firmware, software, or in combinations of them. The invention can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit) or other customised circuitry.

Processors suitable for the execution of a computer program include, by way of example, both general and special purpose CPUs and microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g. EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the invention can be implemented on a device having a screen, e.g., a CRT (cathode ray tube), plasma, LED (light emitting diode) or LCD (liquid crystal display) monitor, for displaying information to the user and an input device, e.g., a keyboard, touch screen, a mouse, a trackball, and the like by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention can be implemented in, e.g., a computing system, a handheld device, a telephone, a consumer appliance, or any other processor-based device. A computing system implementation can include a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a LAN and WAN, e.g., the Internet.

A skilled person will appreciate that variations of the order of the steps, processes and disclosed arrangements are possible.

Accordingly the above description of the specific embodiment is made by way of example only and not for the purpose of limitation. It will be clear to the skilled person that minor modifications may be made without significant changes to the operation described.

1-52. (canceled)

53. A handheld device operable to connect to a data communication network, wherein the device comprises: a screen, a user input device, and a controller adapted to form or change a group that includes the device and at least one other handheld device and adopt a leader device or follower device status; wherein when the leader status is adopted, the controller is adapted to display an item in response to a user input and transmit data indicative of the item to the at least one other device in the group; and wherein when the follower device status is adopted the controller is adapted to receive data indicative of an item from a leader device and display information corresponding to the indicative data.

54. A handheld device as claimed in claim 53, comprising a co-browsing tool to enable the controller to transmit data indicative of the item when the leader status is adopted and to display information corresponding to the indicative data when the follower status is adopted.

55. A handheld device as claimed in claim 53, wherein the indicative data is a url.

56. A handheld device as claimed in claim 53, wherein the controller is operable to allow leader and follower status to be swapped.

57. A handheld device as claimed in claim 53 operable to determine which device in the group first starts or brings into focus an application for viewing the item, wherein leader status is conferred on the determined first device.

58. A handheld device as claimed in claim 57, comprising a clock for monitoring the time at which the application is opened.

59. A handheld device as claimed in claim 53 operable to cause a fixed display device, for example a television, to display the item or information relating to the item when in leader device status.

60. A handheld device as claimed in claim 59 adapted to change the representation of the item or information relating to the item when in leader device status.

61. A handheld device as claimed in claim 59, adapted to cause rotation of the item on the fixed display device when in leader device status.

62. A handheld device as claimed in claim 59, wherein physical rotation of the leader device causes rotation of the item.

63. A handheld device as claimed in claim 59, adapted to transfer control of the fixed display device to another device in the group.

64. A handheld device as claimed in claim 63, wherein transfer is conditional upon receipt of an acceptance signal from the other device.

65. A handheld device as claimed in claim 59 adapted, when in leader status, to indicate to the follower device that the fixed display device is available.

66. A handheld device as claimed in claim 53 adapted to indicate availability to join the group of another handheld device outside of the group.

67. A handheld device as claimed in claim 53, wherein the controller is adapted to change the group by merging the group with another group.

68. A handheld device as claimed in claim 53, wherein the controller is adapted to form or change the group by detecting an event common to a pair of devices.

69. A handheld device as claimed in claim 68, wherein the event comprises at least one of: proximity detection; detection of a tap or shake; detection of a near field communication signal; detection of a spoken command; detection of a gesture.

70. A handheld device as claimed in claim 68 operable to exchange a first time measurement with the other device of the pair, and adopt a leader or follower status in response to a message from the other device based on the first time measurement.

71. A handheld device as claimed in claim 53, where the means to form or change the group is conditional upon a prior preference or indication of acceptance.

72. A handheld device as claimed in claim 71, where the prior preference is to accept or reject inputs from the other devices.

73. A handheld device as claimed in claim 53 configured to display identities of the other devices of the group.

74. A handheld device as claimed in claim 53 operable to display a list of device identities; detect selection of one of the device identities, and join a group that comprises a device corresponding to the device identity selected.

75. A handheld device as claimed in claim 53 configured to establish an audio conference call or text chat session with at least one other handheld device in the group.

76. A handheld device as claimed in claim 53 operable to: record a first time when the group is formed or changed or when a fixed device is caused to display additional information; transmit the first time and the identity of the item to a remote server or device; record a second time corresponding to a transaction time; and transmit the second time and the identity of the item to the remote server or device.

77. A system comprising a plurality of handheld devices according to claim 53, at least one of the devices having leader status and at least one of the devices having follower status.

78. A system as claimed in claim 77, comprising a remote server or device operable to compare a first time a group is formed or changed or when a fixed device is caused to display additional information, and second time corresponding to a transaction time.
